(19) United States
(12) Patent Application Publication
(10) Pub. No.: US 2015/0302347 A1
(43) Pub. Date: Oct. 22, 2015

(54) SYSTEM AND METHOD FOR MANAGING VENUE CONCESSIONS

(71) Applicant: FANS ENTERTAINMENT INC., Montréal (CA)

(72) Inventor: Benoit FREDETTE, Montreal (CA)

(21) Appl. No.: 14/437,619

(22) PCT Filed: Oct. 23, 2013
(86) PCT No.: PCT/CA2013/000911

§ 371 Date: Apr. 22, 2015

Related U.S. Application Data
(60) Provisional application No. 61/717,259, filed on Oct. 23, 2012.

(51) Int. Cl. G06Q 10/08; G06Q 50/12

(52) U.S. Cl. CPC G06Q 10/083; G06Q 50/12

(57) ABSTRACT

There is provided a system and method for synchronizing delivery at a venue of at least one product with a live event occurring at the venue, the at least one product offered at the venue by at least one fulfillment facility. An order signal comprising order data indicative of the order for the delivery of the at least one product to a location of the venue is received. An event signal comprising event data indicative of a timing of the live event is received. It is then determined from the event data a desired delivery time at which to deliver the order to the location such that delivery of the order matches the timing of the live event. A control signal is then generated and transmitted to the at least one fulfillment facility for causing the at least one fulfillment facility to prepare and deliver the order to the location by the desired delivery time.

### CROSS-REFERENCE TO RELATED APPLICATIONS

This patent application claims priority under 35 USC §119(e) of U.S. provisional Application Ser. No. 61/717,259, filed on Oct. 23, 2012, the contents of which are hereby incorporated by reference.

### TECHNICAL FIELD

The present invention relates to the field of providing concession services to patrons at a venue.

### BACKGROUND OF THE ART

When attending an event at a venue, patrons often wish to purchase refreshments, such as food and/or beverages. For this purpose, patrons are typically required to place an order either at a fixed sales emplacement, such as a concession stand, or with roaming staff members present at the venue. Staff members may however be experiencing a high volume of sales, thus requiring patrons to wait for an available staff member to take their order. Patrons may therefore be missing a part of the event, resulting in inconvenience. In addition, roaming vendors usually carry a limited selection of available products, thus reducing the choices available to patrons. Roaming vendors may further walk around the venue for lengthy periods without making any product sale, which leads to inefficient utilization of staff resources. Also, once an order is prepared and ready for delivery, it can be difficult for a roaming staff member to find the patron's location. This may lead to delivery delays and reduced patron satisfaction. Moreover, roaming staff members delivering orders during the course of the event may interfere with the customers' experience, thereby further decreasing their satisfaction.

There is therefore a need for an improved system and method for managing venue concessions.

### SUMMARY

In accordance with a first broad aspect, there is provided a system for synchronizing delivery at a venue of at least one product with a live event occurring at the venue, the at least one product offered at the venue by at least one fulfillment facility, the system comprising a memory; a processor; and at least one application stored in the memory and executable by the processor for receiving an order signal comprising order data indicative of an order for the delivery of the at least one product to a location of the venue, receiving an event signal comprising event data indicative of a timing of the live event, determining from the event data a desired delivery time at which to deliver the order to the location such that delivery of the order matches the timing of the live event, and generating and transmitting a control signal to the at least one fulfillment facility for causing the at least one fulfillment facility to prepare and deliver the order to the location by the desired delivery time.

In some embodiments, the memory has stored therein facility data indicative of an ability of the at least one fulfillment facility to prepare and deliver the order and wherein the at least one application is executable by the processor for retrieving the facility data from the memory, determining from the retrieved facility data and the order data a fulfillment timespan required for the at least one fulfillment facility to prepare and deliver the order, comparing the fulfillment timespan to the desired delivery time, and updating the desired delivery time on the basis of the comparison.

In some embodiments, the memory has stored therein the facility data comprising at least one of a current capacity of the at least one fulfillment facility to prepare the order, a current availability of the at least one fulfillment facility to at least one of prepare and deliver the order, a number of staff at the at least one fulfillment facility, a location of the at least one fulfillment facility, and a location of the staff.

In some embodiments, the at least one application is executable by the processor for updating the desired delivery time comprising determining an alternate desired delivery time if the fulfillment timespan exceeds the desired delivery time, and maintaining the desired delivery time otherwise.

In some embodiments, the memory has stored therein venue data indicative of a physical layout of the venue and wherein the at least one application is executable by the processor for retrieving from the memory the venue data, determining the desired delivery time comprising determining from the retrieved venue data and the order data an optimal route for delivering the order by the desired delivery time, generating the control signal comprising the optimal route, and transmitting the control signal to the at least one fulfillment facility for causing the at least one fulfillment facility to deliver the order according to the optimal route.

In some embodiments, the at least one application is executable by the processor for receiving the order signal comprising the order data indicative of a plurality of orders for the at least one product to be delivered to a plurality of locations of the venue, determining on the basis of at least one of the order data, the facility data, and the venue data one or more subsets of the plurality of orders that minimize a duration taken to deliver each one of the plurality of orders, the optimal route comprising a route for delivering the one or more subsets, generating the control signal indicative of the one or more order subsets, and transmitting the control signal to the at least one fulfillment facility for causing the at least one fulfillment facility to deliver the one or more subsets.

In some embodiments, the at least one application is executable by the processor for receiving the event signal comprising the event data indicative of the timing of at least one activity expected to occur at an activity time during a course of the live event, for determining from the order data an order time at which the order is received, and for determining the desired delivery time comprising determining the activity time chronologically closest to the order time and setting the desired delivery time as the activity time.

In some embodiments, the event data is indicative of the timing of the at least one activity comprising at least one of an interruption, a replay, and an interactive activity.

In some embodiments, the memory has stored therein past event data indicative of occurrence of the expected at least one activity during a course of a past event at the venue, and wherein the at least one application is executable by the processor for retrieving the past event data and applying a probabilistic model to determine from the past event data a probability of occurrence of the expected at least one activity during a course of the live event.

In some embodiments, the at least one application is executable by the processor for determining the fulfillment timespan comprising computing from the facility data a first timespan required for the at least one fulfillment facility to prepare the order and a second timespan required for the at least one fulfillment facility to deliver the order, estimating a third timespan of at least one unexpected event having a potential impact on at least one of preparation and delivery of the order by the at least one fulfillment facility, and computing a sum of the first timespan, the second timespan, and the third timespan to obtain the fulfillment timespan.

In some embodiments, the at least one application is executable by the processor for receiving the order data comprising seat location indicia uniquely identifying a selected one of plurality of physical spaces of the venue, the selected one of plurality of physical spaces uniquely assigned to an attendee having placed the order, and for transmitting the order data and the desired delivery time to the at least one fulfillment facility for causing the at least one fulfillment facility to deliver order to the selected one of plurality of physical spaces.

In some embodiments, the memory has stored therein a plurality of identifiers each uniquely identifying a corresponding one of a plurality of attendees at the venue and having associated therewith at least one attribute for the corresponding one of the plurality of attendees, and the at least one application is executable by the processor for receiving the order data comprising a selected one of the plurality of identifiers, retrieving from the memory the at least one attribute associated with the selected one of the plurality of identifiers, and transmitting the order data and the desired delivery time to the at least one fulfillment facility for causing the at least one fulfillment facility to prepare and deliver order in accordance with the at least one attribute.

In accordance with a second broad aspect, there is provided a a computer-implemented method for synchronizing delivery at a venue of at least one product with a live event occurring at the venue, the at least one product offered at the venue by at least one fulfillment facility, the method comprising receiving an order signal comprising order data indicative of an order for the delivery of the at least one product to a location of the venue; receiving an event signal comprising event data indicative of a timing of the live event; determining from the event data a desired delivery time at which to deliver the order to the location such that delivery of the order matches the timing of the live event; and generating and transmitting a control signal to the at least one fulfillment facility for causing the at least one fulfillment facility to prepare and deliver the order to the location by the desired delivery time.

In some embodiments, the method further comprises retrieving from a memory facility data indicative of an ability of the at least one fulfillment facility to prepare and deliver the order, determining from the retrieved facility data and the order data a fulfillment timespan required for the at least one fulfillment facility to prepare and deliver the order, comparing the fulfillment timespan to the desired delivery time, and updating the desired delivery time on the basis of the comparison.

In some embodiments, the facility data stored in the memory comprises at least one of a current capacity of the at least one fulfillment facility to prepare the order, a current availability of the at least one fulfillment facility to at least one of prepare and deliver the order, a number of staff at the at least one fulfillment facility, a location of the at least one fulfillment facility, and a location of the staff.

In some embodiments, the method further comprises updating the desired delivery time comprising determining an alternate desired delivery time if the fulfillment timespan exceeds the desired delivery time, and maintaining the desired delivery time otherwise.

In some embodiments, the method further comprises retrieving from the memory venue data indicative of a physical layout of the venue, determining the desired delivery time comprising determining from the retrieved venue data and the order data an optimal route for delivering the order by the desired delivery time, generating the control signal comprising the optimal route, and transmitting the optimal route to the at least one fulfillment facility for causing the at least one fulfillment facility to deliver the order according to the optimal route.

In some embodiments, the received order data is indicative of a plurality of orders for the at least one product to be delivered to a plurality of locations of the venue, the method further comprising determining on the basis of at least one of the order data, the facility data, and the venue data one or more subsets of the plurality of orders that minimize a duration taken to deliver each one of the plurality of orders, the optimal route comprising a route for delivering the one or more subsets, generating the control signal indicative of the one or more order subsets, and transmitting the control signal to the at least one fulfillment facility for causing the at least one fulfillment facility to deliver the one or more subsets.

In some embodiments, the received event signal comprises the event data indicative of the timing of at least one activity expected to occur at an activity time during a course of the live event, the method further comprising determining from the order data an order time at which the order is received, and determining the desired delivery time comprises determining the activity time chronologically closest to the order time and setting the desired delivery time as the activity time.

In some embodiments, the event data is indicative of the timing of the at least one activity comprising at least one of an interruption, a replay, and an interactive activity.

In some embodiments, the method further comprises applying a probabilistic model to determine from past event data a probability of occurrence of the expected at least one activity during a course of the live event, the past event data retrieved from a memory and indicative of occurrence of the expected at least one activity during a course of a past event at the venue.

In some embodiments, wherein determining the fulfillment timespan comprises computing from the facility data a first timespan required for the at least one fulfillment facility to prepare the order and a second timespan required for the at least one fulfillment facility to deliver the order, estimating a third timespan of at least one unexpected event having a potential impact on at least one of preparation and delivery of the order by the at least one fulfillment facility, and computing a sum of the first timespan, the second timespan, and the third timespan to obtain the fulfillment timespan.

In some embodiments, the received order data comprises a selected one of a plurality of identifiers retrieved from a memory, each one of the plurality of identifiers uniquely identifying a corresponding one of a plurality of attendees at the venue and having associated therewith at least one attribute for the corresponding one of the plurality of attendees, the method further comprising retrieving from the memory the at least one attribute associated with the selected one of the plurality of identifiers, and transmitting the order data and the desired delivery time to the at least one fulfillment facility for causing the at least one fulfillment facility to prepare and deliver order in accordance with the at least one attribute.

In accordance with a third broad aspect, there is provided a computer readable medium having stored thereon program code executable by a processor for synchronizing delivery at a venue of at least one product with a live event occurring at the venue, the at least one product offered at the venue by at least one fulfillment facility, the program code executable for receiving an order signal comprising order data indicative of the order for the delivery of the at least one product to a location of the venue, receiving an event signal comprising event data indicative of a timing of the live event, determining from the event data a desired delivery time at which to deliver the order to the location such that delivery of the order matches the timing of the live event, and generating and transmitting a control signal to the at least one fulfillment facility for causing the at least one fulfillment facility to prepare and deliver the order to the location by the desired delivery time.

### BRIEF DESCRIPTION OF THE DRAWINGS

Further features and advantages of the present invention will become apparent from the following detailed description, taken in combination with the appended drawings, in which:

FIG. 1a is a schematic diagram of a system for providing services at a venue, in accordance with an illustrative embodiment of the present invention;

FIG. 1b is a schematic diagram of the content provider of FIG. 1a;

FIG. 2a is a schematic diagram of an application running on the processor of FIG. 1a;

FIG. 2b is a schematic diagram of the order processing module of FIG. 2a;

FIG. 2c is a schematic diagram of the delivery synchronization module of FIG. 2b;

FIG. 2d is a schematic diagram of the concession time estimation module of FIG. 2b;

FIG. 2e is a schematic diagram of the delivery time estimation module of FIG. 2d;

FIG. 2f is a schematic diagram of route optimization implemented, in accordance with a first illustrative embodiment, using the route optimization module of FIG. 2e;

FIG. 2g is a schematic diagram of route optimization implemented, in accordance with a second illustrative embodiment, using the route optimization module and the order batching module of FIG. 2e;

FIG. 3a is a flowchart of a method for managing venue concessions, in accordance with an illustrative embodiment of the present invention;

FIG. 3b is a flowchart of the step of FIG. 3a of processing order data;

FIG. 3c is a flowchart of the step of FIG. 3b of selecting a fulfillment facility;

FIG. 3d is a flowchart of the step of FIG. 3b of estimating order fulfillment time by the selected fulfillment facility;

FIG. 3e is a flowchart of the step of FIG. 3b of synchronizing the delivery of an order with the venue event;

FIG. 3f is a flowchart of the step of FIG. 3a of processing payment data;

FIG. 4a is a screen capture of a user interface for registering with the concession management system of FIG. 1a;

FIG. 4b is a screen capture of a user interface for logging into the concession management system of FIG. 1a;

FIG. 4c is a screen capture of a user interface for loading ticket or seat information, in accordance with an illustrative embodiment;

FIG. 4d is a screen capture of a user interface for viewing venue services, in accordance with an illustrative embodiment;

FIG. 4e is a screen capture of a user interface for viewing food/beverage categories for the concession service of FIG. 4d;

FIG. 4f is a screen capture of a user interface for viewing beer items for the beer category of FIG. 4e;

FIG. 4g is a screen capture of a user interface for placing an order, in accordance with an illustrative embodiment;

FIG. 4h is a screen capture of a user interface for presenting an ordering screen, in accordance with an illustrative embodiment; and

FIG. 4i is a screen capture of a user interface for presenting a confirmation screen, in accordance with an illustrative embodiment.

It will be noted that throughout the appended drawings, like features are identified by like reference numerals.

### DETAILED DESCRIPTION

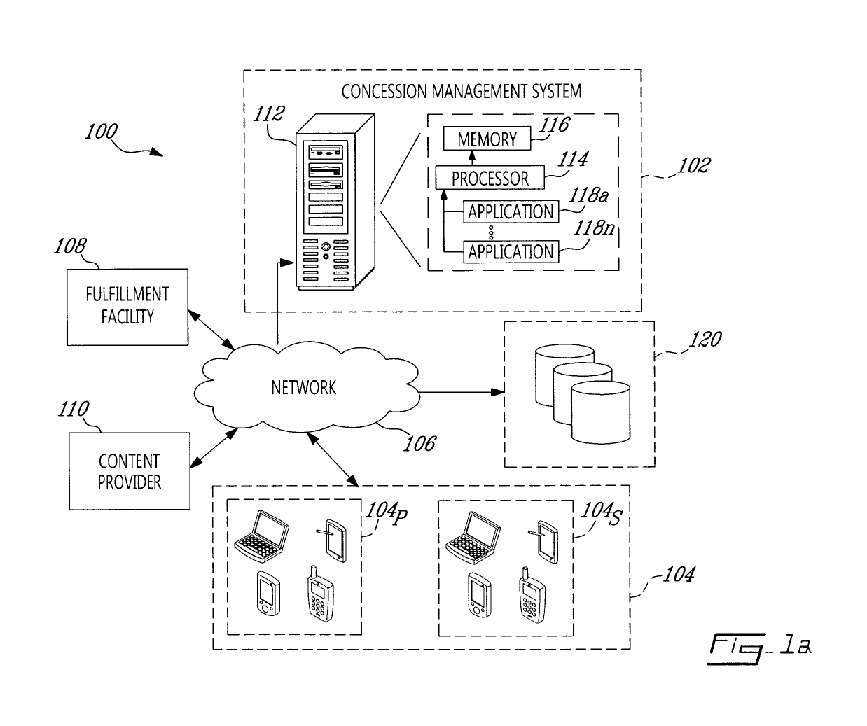

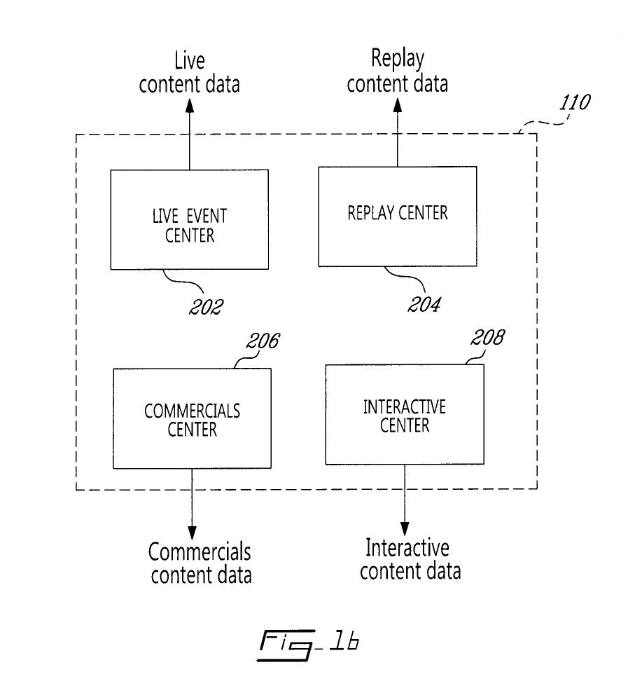

Referring to FIG. 1a, a system 100 for providing services at a venue, such as a stadium/arena, a theater, a concerts hall, or the like, will now be described. It should be understood that although the description below refers to an entertainment venue, e.g. a stadium, other venues, such as hospitality or retail venues may apply. For example, the system 100 may be used at hotels, resorts, camps, amusement parks, relaxation centers, country clubs, convalescence centers, retirement communities, healthcare centers, convention centers, retail locations, and the like.

The system 100 illustratively comprises a concession management system 102. As used herein, the term “concession” refers to a place where patrons or consumers can purchase refreshments, e.g. food and beverages, while at the venue. The term “concession” may also refer to an inventory stockroom, or the like, where the refreshments are prepared and where delivery staff associated with the fulfillment facility 108 stock up. The system 102 is adapted to communicate with a plurality of mobile devices 104 via a network 106, such as the Internet, a cellular network, Wi-Fi, or others known to those skilled in the art. The devices 104 may comprise patron devices 104_{P} that enable patrons present at the venue, to access the concession management system 102 to place orders for a desired product or service offered at the venue. For example, and as will be discussed further below, patrons may order food and beverages using the devices 104_{P}. The devices 104 may comprise any device, such as a laptop computer, a personal digital assistant (PDA), a smartphone, or the like, adapted to communicate over the network 106.

Once the orders are placed, they may be fulfilled at at least one fulfillment facility 108, such as concession stands, kiosks, kitchens, bars, and the like, communicating with the concession management system 102 via the network 106. Although a single concession or fulfillment facility 108 has been shown for illustrative purposes, it should be understood that the system 100 may comprise a plurality of the fulfillment facilities 108. It should also be understood that the fulfillment facility 108 may be a fixed sales emplacement or a mobile sales emplacement, e.g. a food cart. The fulfillment facility 108 may then be located outside the venue, although desirably in close proximity thereto (e.g. near the entrance to the venue). Upon processing of the order at the fulfillment facility 108, one or more staff members may deliver the order to the patron. Such staff members include, but are not limited to, servers, runners, waiters, and other personnel associated with the fulfillment facility 108 and/or the venue. It should be understood that patrons may alternatively pick up their order at the fulfillment facility 108. In one embodiment, each staff member may also be provided with a device 104_{S} for assisting them to better service the patron. As such, the staff member device 104_{S} may display information about the patron's order and other pending orders as well as patron information, e.g. patron's name, room or seat number, billing information, patron device identifier (e.g. phone number), and the like. Moreover, although the description herein refers to orders being made by a patron using their device 104_{P}, it should be understood that orders may also be received from users other than patrons. This may for example be the case if a staff member associated with the venue purchases a concession product prior to presentation of the live event.

In addition, a staff member may use their staff member device 104_{S} to send to the fulfillment facility 108 they are affiliated with a confirmation message indicating that delivery of orders has been completed. When the staff member is making a delivery and reaches the seat of a patron having placed the order being delivered, the staff member may further use their device 104_{S} to send to the patron device 104_{P} a notification message indicating that the order is on its way. This may be done using knowledge of the patron's device identifier. Such a notification message may also be sent to a patron device 104_{P} when the staff member, upon reviewing pending orders presented on their device 104_{S}, identifies that the order of the patron in question is the next pending order to be delivered. In this manner, it is possible to increase the chances that the patron will be at their seat when the staff member reaches the latter to make the delivery.

In some embodiments, upon the patron placing an order, unique identification indicia, such as a visual code (e.g. an image like a square of a given color), an alphanumeric code, or the like, may be generated by the system 102 and output to the patron device 104_{P} for rendering thereon. The identification indicia may also be provided to the staff member device 104_{S} and rendered thereon once the staff member has reached the patron's location. The staff member may then request the patron to present their identification indicia and compare the indicia rendered on the patron device 104_{P} to the identification indicia rendered on their staff member device 104_{S}. If there is a match, the patron is authenticated and the delivery can be made. Otherwise, the staff member can conclude that they are at the wrong location in the venue and/or that the patron in front of them is not the patron that placed the order. Appropriate measures may then be taken to identify the proper location and/or patron.

In some embodiments, the system 102 may require users, e.g. patrons, to log in or otherwise gain authorized access to the system 102 through the use of a unique identifier. For this purpose, patrons illustratively register with the concession management system 102 by completing an application, thereby creating a unique profile or account. This may be done by accessing a website associated with the concession management system 102 and/or the venue using the patron's device 104_{P}. If a patron wishes for his/her future orders or purchases to be paid electronically, i.e. without any bill being physically delivered to the patron, payment information may be provided upon completion of the profile. For example, the patron may provide data associated with an account he/she holds at a financial entity, such as a bank, enter a credit card number that may be used for processing payments, or information related to redeemable corporate vouchers that may be used to purchase goods at the venue.

To complete registration, the user may further provide additional information or attributes, included but not limited to their name, gender, home address, email address, age, and interests. Examples of the attributes include, but are not limited to, income, job status, employment (hours performed, industry, etc.), children, siblings, and family members, studies (completed or ongoing), ethnicity/race, status (e.g. single, married, divorced), primary languages, place of birth, health status, residential are (urban, rural, etc.), credit rating, credit card usage, internet usage, online purchases, computer/mobile devices/software/smartphone and applications usage and purchases, entertainment/sports products and services consumption (spending habits, tickets, merchandising, music, goods etc.).

Once registration is complete, each patron is illustratively provided with a unique identifier, such as a username and password, associated with his/her profile. The identifier may be used to verify the identity of the patron and for processing payments. The patron may then access the concession management system 102 by logging on to the website using the identifier.

Once having been granted access to the system 102, the patron may subsequently load therein information about their ticket and/or seat number at the chosen venue. This ticket information may be provided subsequent to the patron scanning a portion or the entirety of their ticket. In particular, at least the ticket number and seat number may then be obtained from a ticket issuer and loaded into the system 102 and/or the databases 120 further to the scanning process. The information may also be manually entered by the patron using suitable interface elements (not shown) presented on the device 104_{P}. Alternatively, the concession management system 102 may be installed on the device 104_{P} (and on the staff member device 104_{S}) as a software application, which may be launched by the patron on the device 104_{P} for accessing the concession management system 102. It should be understood that the system 102 may be accessed by multiple users simultaneously. In this manner, a large volume of consumers may be supported. It should also be understood that the patron may log into the system 102 using an identifier associated with an online social network or social networking application (e.g. Facebook™, Google+™, Twitter™ or the like) to which the patron has subscribed.

As will be discussed further below, in order to synchronize delivery of the order with an event occurring at the venue, the concession management system 102 may further communicate with a content provider 110 offering the event to users. Although the description below refers to a live event, such as a sports game, it should be understood that various events may apply. For example, the event may relate to an activity, such as a massage, downhill skiing, shopping, or the like, undertaken by the patron at a hospitality or retail venue. In this case, the content data may comprise calendar information, appointment information, and the like. Also, the content data may or may not be provided by a content provider 110.

As shown in FIG. 1b, in one embodiment, the content provider 110 illustratively comprises a live event center 202, a replay center 204, a commercials center 206, and an interactive center 208. Although not illustrated, it should be understood that the content provider 110 may further comprise (or communicate with) a ticketing system, which may have access to information associated with a given ticket, e.g. patron's identification and/or seat number corresponding to a given ticket number. As discussed above, the ticket information may be obtained from the ticketing system further to the patron scanning their ticket. For this purpose, the ticketing system illustratively records (e.g. in the databases 120) the location and numbers of all seats for the venue, an identification of all tickets (and corresponding ticket numbers) issued for the event occurring at the venue, and an identification of each patron having purchased a ticket for the event.

The live event center 202 illustratively presents live content at the venue. As known to those skilled in the art, live content may be viewed by patrons at the setting, e.g. scene, stage, field, or the like, of the event. Audio and video footage of the event may further be captured by cameras present at the venue and the resulting live content data may be rendered by the live event center 202 to output devices, e.g. screens and speakers, provided at the venue. In addition, the live content data may be broadcasted by the live event center 202 to the devices 104_{P}. In particular, news feeds and highlights about the event may be provided to the devices 104_{P} and updated in real time. Exclusive content, such as interviews and exclusive audio and video streams, may also be provided.

The replay center 204 illustratively provides replays of the current live event as replay content data that may be transmitted to the devices 104_{P} upon request. Video footage of the event may be replayed immediately or at any other time after the event has occurred. For example, instant replays may be presented by the replay center 204 during a break or lull in the live broadcast of the event. Replays may enable patrons to view passages of the event that were important or remarkable or passages, which were unclear on first sight. It should be understood that patrons may choose to have any other passage of the event replayed by the replay center 204. The commercials center 206 illustratively provides commercials content data that is presented during intermissions or breaks in the live event or prior to presentation of the replays. In this manner, a variety of goods and services may be promoted to the patrons. The interactive center 208 illustratively provides interactive content data, such as crowd sourcing games, contests, quizzes, live surveys, chatroom services, and the like, which may be presented on the devices 104_{P} concurrently with or outside of the live event to foster user interaction and engagement. The content data provided by the content provider 110 may be tailored to the event, the venue, and/or the preferences of the patron, as indicated in their profile. As such, the content provider 110 may comprise at least one of the centers 202, 204, 206, and 208.

In one embodiment, it may be possible to tailor the content data provided to the to the devices 104_{P} and/or the products offered at the venue via the fulfillment facility 108 to the event attendees. For this purpose, the content provider 110, the fulfillment facility 108, and/or the concession management system 102 may be provided access to (e.g. retrieve) the user profile information provided to the concession management system 102 upon users registering therewith. Using the profile information, it may then be possible to determine the content and/or product offerings best suited to the users. For example, an under-aged user may access the system 102 using their device 124_{P}. As the user's profile may indicate that they are not of legal drinking age, only non-alcoholic beverages may be presented and made available for request (and accordingly delivery) on the user's device 124_{P}. Alternatively, all beverages, including alcoholic beverages, may be presented on the device 124_{P} but a warning message may be output when the user makes a request for an alcoholic beverage. Warning messages may also be output to the fulfillment facility 108, and more particularly to the staff member devices 124_{A}, to prompt delivery personnel to authenticate the identity (e.g. request identification cards indicative of age) of patrons when deliveries are made for alcoholic beverages. In other embodiments, the concession products made available on the device 124_{P} may be tailored to demographics (e.g. gender) or other characteristics of the users accessing system 102. In this manner, product offerings may be targeted to the audience at the venue.

Referring back to FIG. 1a, the concession management system 102 may comprise one or more server(s) 112. For example, a series of servers corresponding to a web server, an application server, and a database server may be used. These servers are all represented by server 112 in FIG. 1a. The server 112 may comprise, amongst other things, a processor 114 coupled to a memory 116 and having a plurality of applications 118a, . . . , 118n running thereon. The processor 114 may access the memory 116 to retrieve data. The processor 114 may be any device that can perform operations on data. Examples are a central processing unit (CPU), a microprocessor, and a front-end processor. The applications 118a, . . . , 118n are coupled to the processor 114 and configured to perform various tasks as explained below in more detail. It should be understood that while the applications 118a, . . . , 118n presented herein are illustrated and described as separate entities, they may be combined or separated in a variety of ways. It should be understood that an operating system (not shown) may be used as an intermediary between the processor 114 and the applications 118a, . . . , 118n. Also, although the system 102 is described herein as comprising the processor 114 having the applications 118a, . . . , 118n running thereon, it should be understood that cloud computing may also be used. As such, the memory 116 and/or databases 120 may comprise cloud storage.

The memory 116 accessible by the processor 114 may receive and store data. The memory 116 may be a main memory, such as a high speed Random Access Memory (RAM), or an auxiliary storage unit, such as a hard disk or flash memory. The memory 116 may be any other type of memory, such as a Read-Only Memory (ROM), Erasable Programmable Read-Only Memory (EPROM), or optical storage media such as a videodisc and a compact disc.

One or more databases 120 may be integrated directly into the memory 116 or may be provided separately therefrom and remotely from the server 112 (as illustrated). In the case of a remote access to the databases 120, access may occur via any type of network 106, as indicated above. The databases 120 described herein may be provided as collections of data or information organized for rapid search and retrieval by a computer. The databases 120 may be structured to facilitate storage, retrieval, modification, and deletion of data in conjunction with various data-processing operations. The databases 120 may consist of a file or sets of files that can be broken down into records, each of which consists of one or more fields. Database information may be retrieved through queries using keywords and sorting commands, in order to rapidly search, rearrange, group, and select the field. The databases 120 may be any organization of data on a data storage medium, such as one or more servers.

In one embodiment, the databases 120 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). Identity verification of a user may be performed using usernames and passwords for all users. Various levels of access rights may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

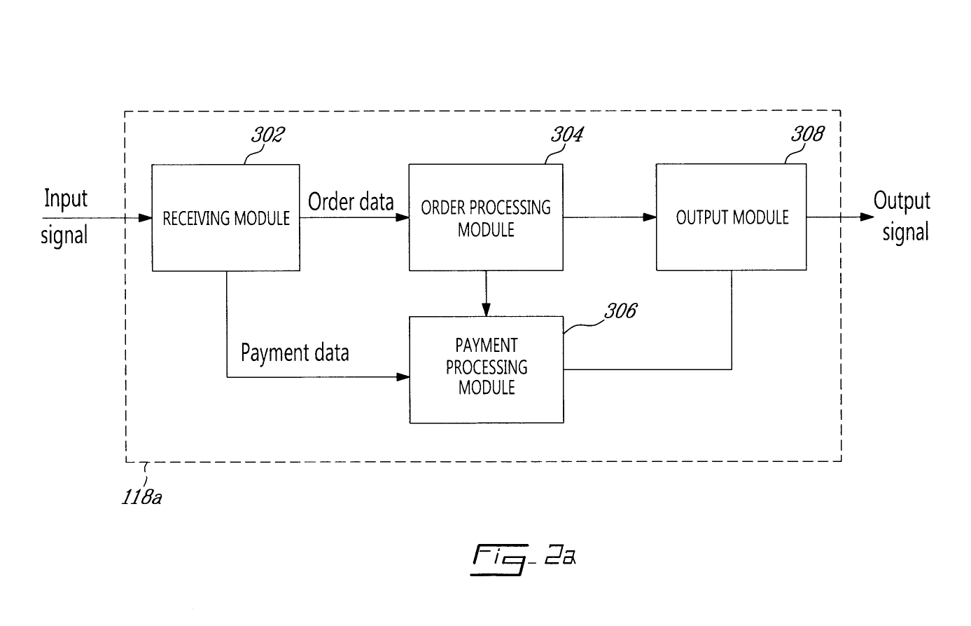

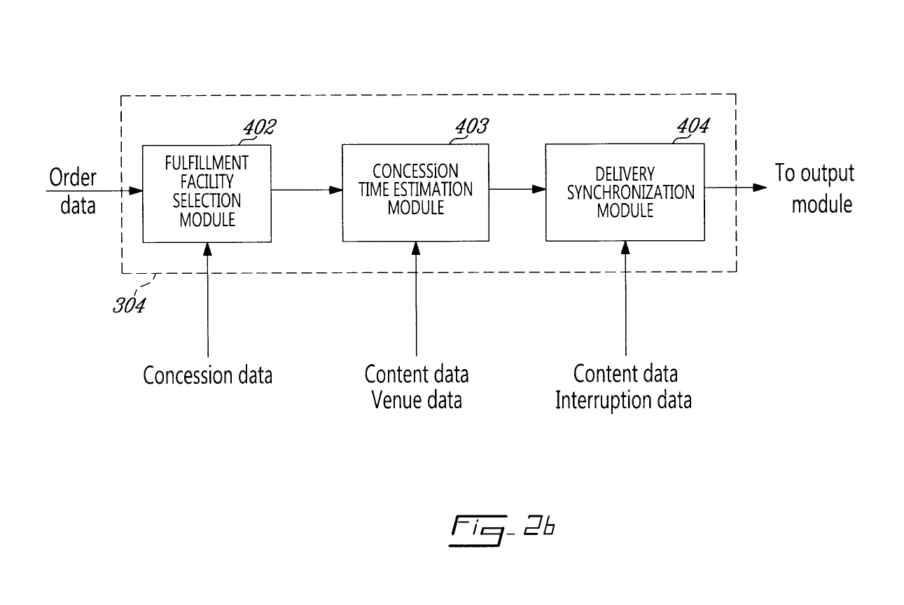

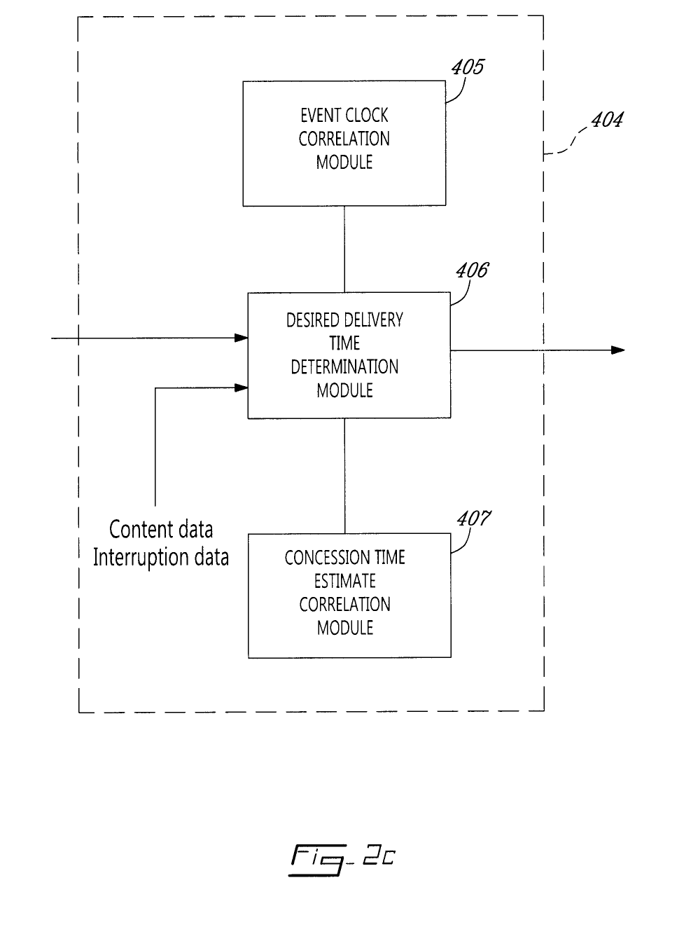

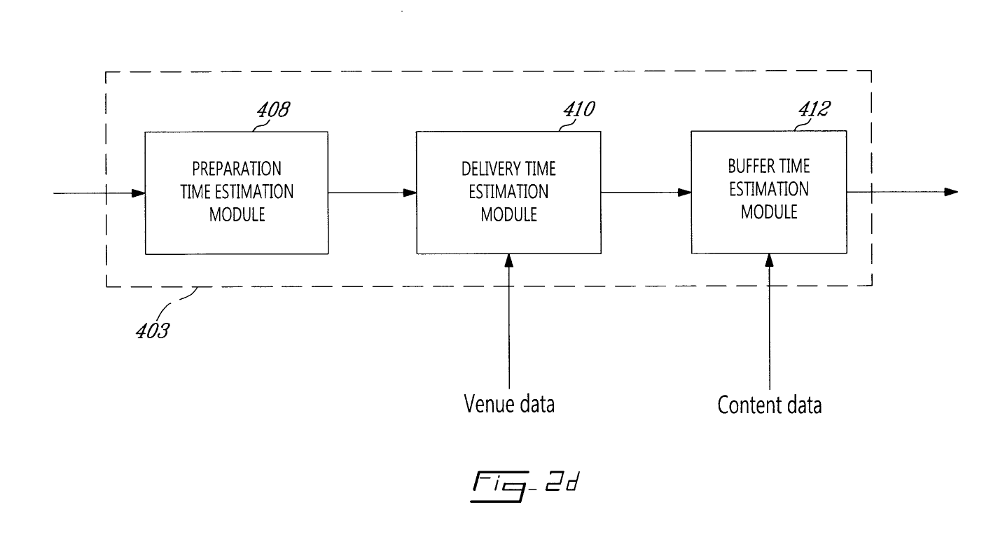

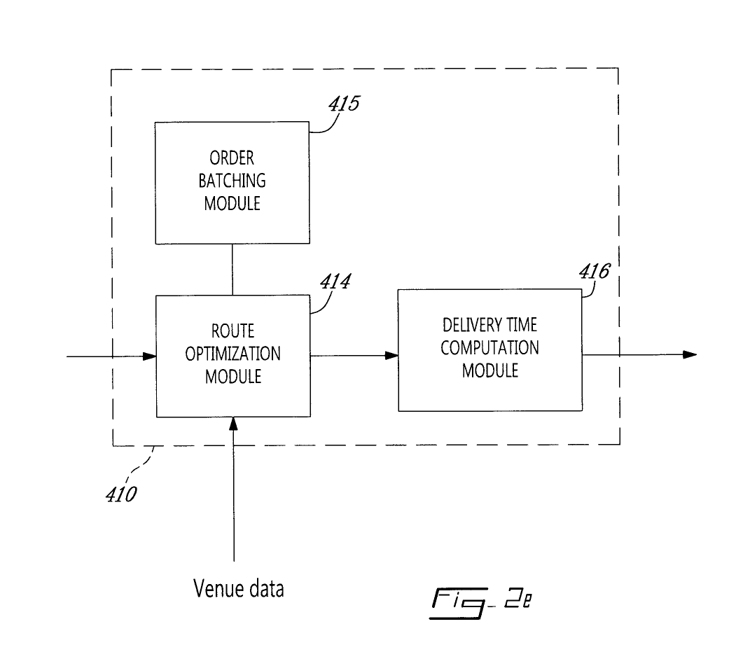

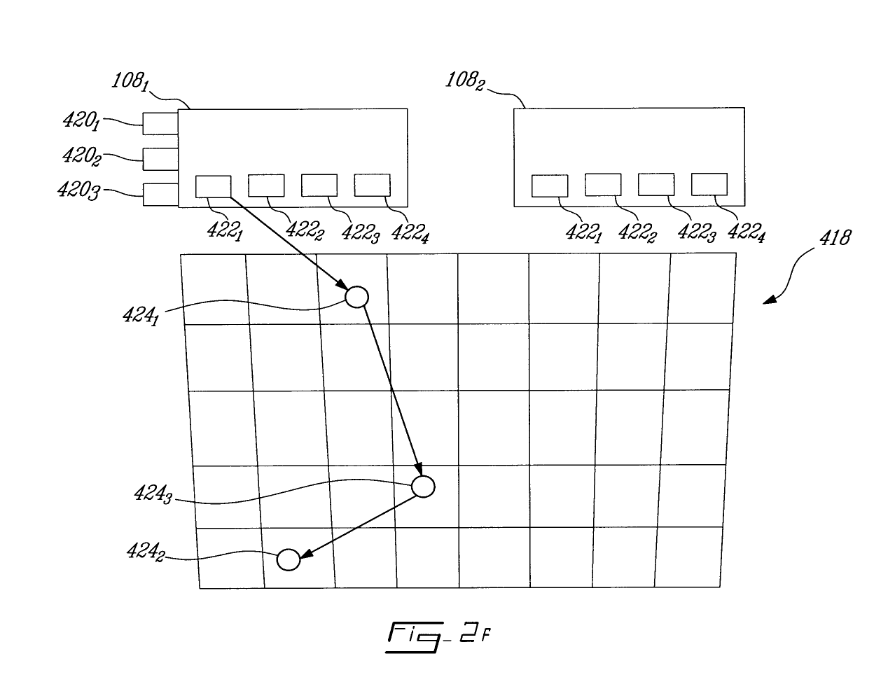

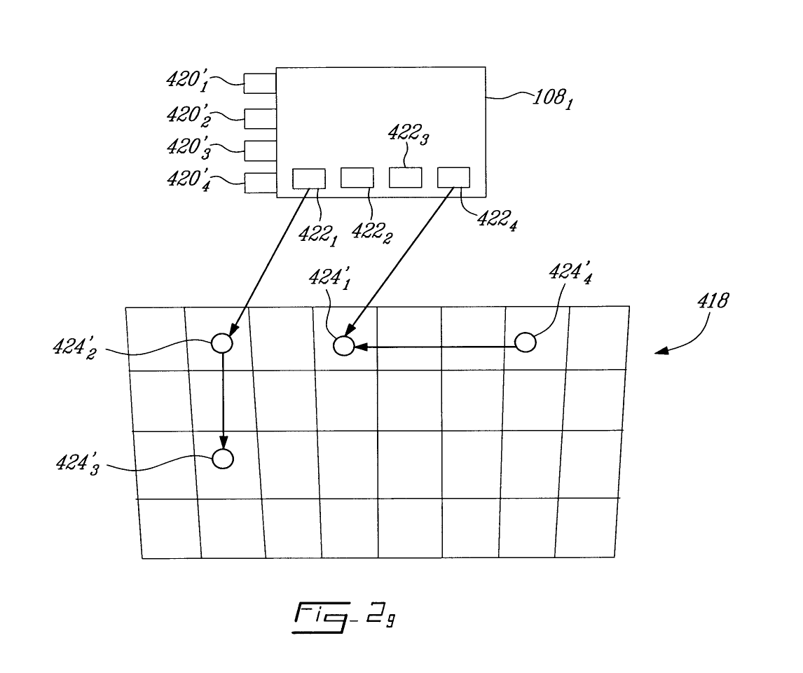

FIG. 2a is an exemplary embodiment of an application 118a running on the processor 114. The application 118a illustratively comprises a receiving module 302, an order processing module 304, a payment processing module 306, and an output module 308. The receiving module 302 illustratively receives an input signal from a patron device 104_{P}. The input signal may comprise data relating to an order placed by the patron or payment data provided by the patron to proceed with payment of a previously placed order. The order data may comprise information about the order, e.g. the type and number of items ordered, as well as information about the patron, such as a seat number allowing for localization of the patron within the venue, a venue ticket number, a name of the patron, and the like. The payment data may comprise credit card information, financial account numbers, account debit authorizations, electronic funds transfer information, and other relevant payment information known to those skilled in the art. Upon receiving the input signal, the receiving module 302 illustratively discriminates between the order data and the payment data. When order data is received, the data may be sent to the order processing module 304 for fulfilling the patron's order in an optimized manner, as will be discussed further below.

When payment data is received, the receiving module 302 transmits the payment data to the payment processing module 306, which processes the data to proceed with the payment. In particular, before making the payment final, the payment processing module 306 may first generate a payment confirmation request to be sent to the patron so the latter may confirm their desire to make a payment. After receiving the payment confirmation from the patron, the payment processing module 306 may then charge a credit card or financial account of the patron as per the payment data. Payment data may alternatively be received directly from the order processing module 304. This may for example be the case when the patron chooses to use stored information, e.g. credit card information, provided in his/her profile to proceed with the payment rather than entering his/her payment information. As such, the payment information may be retrieved from the patron's profile and sent directly to the payment processing module 306 upon the patron placing the order. In one embodiment, the payment confirmation request may be generated once the order data is received at the receiving module 302. Upon receiving the confirmation of the payment from the patron, the payment processing module 306 may cause the payment to be pre-authorized prior to the order processing module 304 processing the order and the patron confirming acceptance of delivery of the order. The output of the payment processing module and/or the output of the order processing module 304 may then be sent to the output module 308, which generates an output signal comprising data to be rendered on an interface, e.g. a screen, of the patron's device 104_{P}.

It should be understood that the receiving module 302 may take into account the time interval between the reception of successive input signals to determine whether data from an input signal should be transmitted to the order processing module 304 and/or the payment processing module 306. Indeed, an input signal may be generated as a result of a user inadvertently selecting via a user interface presented on their device 104_{P} a concession product for delivery. For example, if selection is made on a touchscreen, this may occur if the user's finger slipped and selected the wrong product. It may therefore be desirable to discriminate between erroneous and rightful input. For this purpose, the receiving module 302 may compare the time interval between inputs to a predetermined threshold, e.g. one (1) second. If the time interval between inputs is lower than the threshold, it may be determined that the user did not spend enough time considering the currently received selection. Thus, the receiving module 302 may conclude that an erroneous selection has been received. The receiving module 302 may then send a signal to the output module 308 to trigger the presentation on the device 104_{P} of a message prompting the user to confirm his/her selection. Otherwise, if the time interval between inputs is greater than the threshold, the receiving module 302 may conclude that a rightful selection has been made and transmit the received input data to the order processing module 304 and/or the payment processing module 306.

Referring to FIG. 2b, the order processing module 304 illustratively comprises a fulfillment facility selection module 402, a concession time estimation module 403, and a delivery synchronization module 404.

The fulfillment selection module 402 illustratively receives the order data from the receiving module 302 and may then retrieve from the memory 116 and/or databases 120 concession data related to the fulfillment facility 108. The concession data may be periodically received from the fulfillment facility 108 and stored in the memory 116 and/or databases 120. The concession data may indicate the current availability of the fulfillment facility 108, the current capacity of the fulfillment facility 108 to fulfill the order, the number of staff members at the fulfillment facility 108, and the localization of the fulfillment facility 108 and/or its staff members. A fulfillment facility 108 may be currently available to process an order if the facility 108 is open for business or not otherwise committed, such as in the case of all staff members of the facility 108 busy delivering orders to patrons at the venue. A fulfillment facility 108 may currently have the capacity to process an order if stock for the desired products is available and/or the facility 108 could benefit from more order volume.

The fulfillment facility selection module 402 may then search the retrieved concession data to identify which fulfillment facility 108 is available to process the patron's order. Once at least one available fulfillment facility 108 has been identified, the fulfillment facility selection module 402 may then search the concession data associated with the at least one identified available fulfillment facility 108 to determine whether the latter has the capacity to fulfill the patron's order. If it is determined that a subset of the at least one available fulfillment facility 108 has the required capacity, the fulfillment facility selection module 402 may then search the concession data of each fulfillment facility 108 in the subset to determine a localization of the fulfillment facility 108 and/or a localization of the facility's staff members. If the subset of fulfillment facilities 108 comprises more than one suitable fulfillment facility 108, i.e. having the required capacity and availability, the fulfillment facility selection module 402 may then select the fulfillment facility 108 that is closest to the patron's location, e.g. seat number, as obtained from the order data and/or the patron's profile information. If the subset of suitable fulfillment facilities 108 comprises only one fulfillment facility 108 by the fulfillment facility selection module 402, the identified fulfillment facility 108 may be chosen. It should be understood that the fulfillment facility selection module 402 may use one or more criteria to determine the fulfillment facility 108 suitable for fulfilling the patron's order.

It should be understood that any location information may be obtained using a positioning system, e.g. Global Positioning System (GPS) system, or other localization techniques known to those skilled in the art. In one embodiment, the seats of the venue may be equipped with transmitters and/or receivers (not shown), using any suitable communication technology, such as Wi-Fi or the like, as indicated in equipment characteristics provided in the venue data. When such transmitters and/or receivers are provided, they may each be coded so as to be uniquely matched to the identifier of the user to which the corresponding seat has been assigned. Each transmitter may then output to a suitable receiver (not shown) provided at the venue a signal comprising the identifier of the user assigned to the seat in question. It should be understood that any given seat may be equipped with both a transmitter and a receiver. It should also be understood that the transmitters/receivers may be provided at places other than the venue seats, e.g. at an entrance of the venue, to enable localization of users when the latter are not at their seats. The transmitter may then send a transmit signal, such as a “ping” signal or the like, towards the receiver, which upon receiving the transmit signal outputs a return signal to the transmitter. The return signal illustratively comprises data confirming coordinates of the receiver. Alternatively, triangulation may be used to determine coordinates. The localization of all users in the venue can then be obtained. In one embodiment, the fulfillment facility selection module 402 may select more than one fulfillment facility 108 for processing the patron's order. In particular, this may occur when patron orders may be split among a plurality of fulfillment facilities 108. For example, a patron may order three (3) beverages. The fulfillment facility selection module 402 may determine that only two (2) fulfillment facilities 108 are available to take the order, with the first fulfillment facility 108 carrying two (2) of the desired beverage and the second fulfillment facility 108 carrying only one (1). The fulfillment facility selection module 402 may therefore select both fulfillment facilities 108 and split the order therebetween.

Once at least one fulfillment facility 108 has been identified by the fulfillment facility selection module 402, the order data and the concession data associated with the identified fulfillment facility 108 may be sent to the concession time estimation module 403. The concession time estimation module 403 may then compute an estimate of the time it should take the identified fulfillment facility 108 to prepare and subsequently deliver the patron's order. This estimation may be done on the basis of the received order data and concession data, as will be discussed further below. Data related to the venue, e.g. a configuration or layout thereof, may also be used by the concession time estimation module 403 to compute the estimates. In particular, the concession time estimation module 403 may correlate the order data with the concession data, e.g. the capacity and the number of staff members at the fulfillment facility 108, to determine how long the chosen fulfillment facility (or facilities) 108 should be expected to take to prepare and deliver the order. In estimating the preparation and delivery times, the concession time estimation module 403 may further take into account unexpected events that may affect the preparation and delivery of the order. The concession time estimation module 403 may accordingly estimate a buffer time to be added to the preparation and delivery estimates to provide a more accurate approximation of the expected delivery time for the order. Once the concession time estimates have been computed, they may be sent together with the order and concession data to the delivery synchronization module 404.

The delivery synchronization module 404 illustratively enables synchronization of the delivery of the patron's order with the live event occurring at the venue. In particular, the delivery may be synchronized with the live event being presented at the venue and/or with the live content data broadcasted by the live event center 202 to the patron's device 104_{P}. For example, the delivery may be synchronized with interruptions (e.g. with commercial breaks and/or intermissions) periodically occurring during the event. It should be understood that the delivery may be synchronized with content, other than live content, presented on the devices 104_{P}. For instance, when the patron is viewing replays on his/her device 104_{P}, the delivery may be synchronized with the timing of the replays. The delivery may further be synchronized with the timing of an interactive content or activity, e.g. a quiz, presented on the patron's device 104_{P}. For this purpose, and as illustrated in FIG. 2c, the delivery synchronization module 404 illustratively comprises an event clock correlation module 405, a desired delivery time determination module 406, and a concession time estimate correlation module 407.

In order to achieve synchronization, the desired delivery time determination module 406 illustratively retrieves from the content provider 110, memory 116, and/or databases 120, upon the delivery synchronization module 404 receiving the order data and the concession data from the fulfillment facility selection module 402, content data presented to the devices 104_{P} and/or at the venue. In particular, the desired delivery time determination module 406 may retrieve the live content data, the replay content data, the commercials content data, and the interactive content data provided by the content provider 110. When interactive content is presented on the device 104_{P}, such content data may also have been stored in the memory 116 and/or databases 120 and may be retrieved therefrom by the desired delivery time determination module 406.

The retrieved content data may comprise information about the timing of the content to be presented on the device 104_{P} and/or at the venue. For example, upon retrieving the live content data, the desired delivery time determination module 406 may be able to determine the timing of the live event and identify interruptions or breaks, e.g. time-outs or intermissions, in presentation of the live content. In one embodiment, the desired delivery time determination module 406 may estimate from the retrieved live content data and commercials data at which points during the live broadcast the commercials are to be presented (e.g. estimate a timing of half-times or intermissions, which are typically set of occur at predetermined times during a course of the event). As such, the desired delivery time determination module 406 may identify breaks in the live action and estimate therefrom the timing of the next intermission or commercial break. The desired delivery time determination module 406 may then set the desired delivery time of the patron's order to match the time of the next intermission (i.e. the intermission occurring at a time closest in chronological order to the time at which the order was placed). For example, the desired delivery time determination module 406 may generate delivery timing data indicating that the desired delivery time is to be substantially equal to the time the next intermission is expected to end.

The delivery timing data may also indicate a timeframe, e.g. between the beginning and the end of the next commercial break, during which the order should be delivered. For instance, the patron may have placed his/her order at the beginning of a commercial break and the timing of the content data may indicate that the commercial break is to end in three (3) minutes. The desired delivery time determination module 406 may then determine that the desired delivery time is within the next three (3) minutes. It should be understood that the delivery timing data may vary depending on the type of content presented to the patron and/or on the patron's preferences. In one embodiment, it may be desirable for deliveries to be made during interruptions (e.g. commercials) in the course of the live event or while other activities (e.g. replays, interactive activities) are occurring or presented. If it is determined that a delivery cannot be made in time for an upcoming interruption or activity (e.g. due to a lack of availability or capacity of the fulfillment facility 108 or because the patron placed their order close to or after the end of the interruption or activity), the patron may be notified that the delivery will be made at the following interruption or activity. The patron may then choose to proceed with the order or cancel the latter.

It should also be understood that information about the timing of the live content may be provided manually by an operator, a technician, or other staff member associated with the venue and/or the content provider 110. For example, when a time-out in the live action occurs, the operator may manually trigger the transmission of a signal indicating such an interruption. The signal may comprise interruption data indicating that a time-out has occurred in the live action. The interruption data may further indicate when the live action is to resume. The signal may then be received at the receiving module 302, which may transmit the interruption data to the desired delivery time determination module 406 of the delivery synchronization module 404. The desired delivery time determination module 406 may then determine from the received interruption data that an interruption has occurred in the live action. The desired delivery time determination module 406 may further be able to determine from the interruption data when the live action is expected to resume and accordingly estimate the ideal time for delivering the order to the patron.

In one embodiment, the delivery synchronization module 404 synchronizes the delivery of the patron's order with the live event by differentiating the event time from the standard time (e.g. the civil or local time indicated by standard clocks). This may be the case when the live event is a sports game or any other event having its own timing and duration, which may be determined by an independent clock or timer. In particular, a football game is typically divided into two (2) halves of thirty (30) minutes and four (4) quarters of fifteen (15) minutes. A game clock may then be used to keep track of the official time for the game and is illustratively set to 15:00 at the beginning of each quarter. The game clock may also be used to time the halftime period, which lasts twelve (12) minutes during the regular season. The game clock stops during breaks in the game, after incomplete passes, during time-outs, and while plays are being reviewed by the officials. It also stops at the two-minute warning at the tail end of each half (i.e. of the second and fourth quarters). As such, the game time clearly differs from the standard time and two (2) minutes on the game clock may correspond to six (6) minutes in standard time.

When an order is received at the order processing module 304 and reaches the delivery synchronization module 404, the desired delivery time determination module 406 may first determine from the order data the time (e.g. standard time) at which the order was placed by the patron. The desired delivery time determination module 406 may then retrieve from the content provider 110, memory 116, and/or databases 120 the content data presented to the devices 104_{P} and/or at the venue, the retrieved content data providing event clock information indicative of a timing of the event (e.g. the official game time). The desired delivery time determination module 406 may then communicate with the event clock correlation module 405, which may be used to correlate the order time with the official game time. In particular, the event clock correlation module 405 may correlate the official game time with the standard time by determining which moment of the event clock corresponds to the standard time at which the order was placed. The desired delivery time determination module 406 may then estimate from the data received from the event clock correlation module 405 the activities expected to next occur during the game according to the game clock. For instance, the desired delivery time determination module 406 may determine when a predetermined interruption (e.g. half-time) is to next occur in the game. The desired delivery time may then be set to the time of the interruption so that the order is delivered to the patient in synchronism with the timing of the interruption.

For example, the order data may indicate that the patron placed an order at a given standard time. The event clock correlation module 405 may then determine from the event clock information the order has been placed after the first fifteen minutes of the game, i.e. after the end of the first quarter. In some embodiments, it may be desirable to avoid deliveries during intermissions and this may be indicated in the content data and/or the venue data. The desired delivery time determination module 406 may then determine that it is desirable for the patron's order to be delivered at the beginning of the second quarter and may set the desired delivery time accordingly.

The event clock correlation module 405 may further use the event clock information to forecast a likelihood that upcoming actions or activities with a certain timing or pace may occur during the course of the event. Using the correlation information obtained from the event clock correlation module 405, the desired delivery time determination module 406 may then estimate a suitable moment at which it may be appropriate to deliver the patron's order without interfering with the patron's experience at the venue.

For instance, the event clock information may be indicative of a previous pace at which the event clock has been running since the beginning of the event. Alternatively, the content data may be indicative of a previous pace at which the event clock had been running for past events of a nature similar to the current event. Using the event clock information (e.g. knowledge of the previous pace), the event clock correlation module 405 may then estimate a pace at which the event clock for the current event is expected to run. For this purpose, the event clock correlation module 405 may apply a probabilistic model (e.g. with normal distribution), which in some embodiments takes into account the event clock information. The event clock correlation module 405 may then determine a probability that the pace of the current event will vary (i.e. that the event clock will run at a faster or slower pace) or remain the same provided the event clock keeps running. The desired delivery time determination module 406 may then estimate from the forecasted pace at what time(s) it may be fitting to deliver orders.

For example, the event clock correlation module 405 may determine from the content data that the event (e.g. official game) clock has been running at a fast pace during a beginning of the first quarter but that the pace has significantly slowed down towards the end of the first quarter. The event clock correlation module 405 may then determine that there is a high probability that the event clock will remain slow at the beginning of the second quarter but that the pace will increase towards the end of the second quarter. As such, the desired delivery time determination module 406 may set the desired delivery time to the beginning of the second quarter, where the game is expected to run at a slow pace, rather than setting the desired delivery time towards the end of the second quarter, where the game is expected to run at a fast pace. In this manner, it becomes possible to avoid interfering with the patron's enjoyment of the event. It should be understood that once the standard time and the game time (e.g. the standard clock and the event clock) have been correlated, the desired delivery time may be set in at least one of standard time and game time.

In another embodiment, the event clock correlation module 405 may determine that a present sports game currently presented at the venue is running at a same pace as a previous sports game previously presented at the venue, both the present and previous sports game involving the same teams. The event clock correlation module 405 may then forecast (e.g. with a given probability) that actions or activities similar to those that have occurred in the previous game are likely to occur in the current game. For example, the event clock information for a past concert having occurred at a venue may indicate that the artist took a break of several (e.g. three (3)) minutes between the third and fourth songs, e.g. more emotional songs. If the current event is a concert by the same artist, the event clock correlation module 405 may then determine that it is likely that there will be an interruption of three (3) minutes after the third song is played. The desired delivery time determination module 406 may then identify the three-minute interruption between the third and fourth songs as a suitable time for delivering an order placed by a patron at the beginning of the third song. It should be understood that the event clock information may comprise various information, which may be used to forecast actions or activities, and accordingly a timing thereof. For example, information including, but not limited to, a type of the event, performer(s) involved (e.g. artists or team players), and a content presented, may apply.

In addition to estimating the optimal delivery time from the timing of the content data, the desired delivery time determination module 406 may further use the concession time estimate correlation module 407 to compare the desired delivery time to the time estimates output by the concession time estimation module 403. In particular, upon determining from the timing of the live content the desired delivery time, the concession time estimate correlation module 407 may assess whether the order may meet such a desired delivery time on the basis of the concession time estimates. Indeed, staff member may not be able to deliver a prepared order according to the desired delivery time if the preparation and delivery times estimated by the concession time estimation module 403 exceed the desired delivery time estimated by the desired delivery time determination module 406. For example, the concession time estimation module 403 may have determined that the chosen fulfillment facility 108 is expected to take eight (8) minutes to prepare the order and staff member five (5) minutes to deliver the prepared order. The concession time estimate correlation module 407 may therefore determine that the order is likely to be delivered within the next thirteen (13) minutes instead of within a desired ten (10) minutes determined from the timing of the content data, as discussed in the example above. Using the analysis from the concession time estimate correlation module 407, the desired delivery time determination module 406 may therefore update the previous estimate for the desired delivery time. For example, it may be determined that, since the order may not be delivered in time prior to the end of the present intermission, it may be suitable to deliver the order during the following intermission.

After determining when it is desired to deliver the patron's order given the content data, the preparation and delivery time estimates for the identified fulfillment facility 108, the desired delivery time determination module 406 may then generate a control signal comprising the order data as well as the desired delivery time for the order. The control signal may further comprise unique identification indicia generated by the desired delivery time determination module 406 for the order at hand. As discussed above, the identification indicia may be used by a staff member to authenticate the patron having placed the order being delivered by the staff member. The control signal may then be sent to the output module 308, which may in turn format the order data and the delivery timing data for transmission to the patron's device 104_{P}. This may cause presentation on the patron's device 104_{P} of a message indicating that the order is being processed and when to expect delivery of the order. Upon transmission of the signal to the device 104_{P}, the patron may further be provided with the option to confirm the order, cancel the order, or provide an alternate delivery time, if desired.

The output module 308 may further format the data for transmission to the fulfillment facility (or facilities) 108 identified by the fulfillment facility selection module 402. In this manner, the order may be dispatched to the chosen fulfillment facility 108 and processed thereat. As the fulfillment facility 108 illustratively receives both the order data and the delivery timing data, the facility 108 may ensure that the patron's order is delivered at the time indicated in the delivery timing data. The synchronization determined by the delivery synchronization module 404 may then be achieved, resulting in optimal preparation and delivery time relative to the event occurring at the venue. Patrons may therefore receive their order at the most suitable time and without any delays being incurred, thereby increasing their satisfaction and improving their overall experience. The output module 308 may transmit data to the devices 104 and/or the fulfillment facility 108 through instant push notifications sent via the network 106. Email, Short Message Service (SMS), Multimedia Messaging Service (MMS), instant messaging (IM), or other suitable communication means known to those skilled in the art may also apply.

In one embodiment, an order confirmation request message may be generated and output to the devices 104 for requesting confirmation of the order by the patron. This confirmation message may be generated and output prior to the order being dispatched to the chosen fulfillment facility 108. Such dispatching may then only be performed upon receipt of a confirmation signal indicating that the patron confirms the order.

Referring back to FIG. 2a, it should be understood that the order processing module 304 may further periodically update a previously received order from a patron. For this purpose, the order data received at the order processing module 304 may comprise updates, such as order or concession update data. The order update data may, for example, comprise an indication that the patron has modified their previous order. The concession update data may indicate that a previously selected concession is no longer available due to an unexpected event, e.g. sudden sickness of a staff member. The concession update data may also indicate that an order has been prepared quicker than expected or than a staff member has entered the patron's section and/or seat area sooner than expected. Upon receiving such update data, the receiving module may send it directly to the fulfillment facility selection module 402 of the order processing module 304. The fulfillment facility selection module 402 may then select a new fulfillment facility 108, if needed, or send the update data to the concession time estimation module 403 for updating previous preparation and delivery time estimates associated with the order in question. The updated time estimates and updated order and/or concession data may then be sent to the delivery synchronization module 404. The delivery synchronization module 404 may then generate new delivery timing data indicative of the updated desired delivery time. The updated data may then be sent by the delivery synchronization module 404 to the output module 308 for transmission to the patron's device 104_{P} and/or fulfillment facility 108.

Referring now to FIG. 2d, the concession time estimation module 403 illustratively comprises a preparation time estimation module 408, a delivery time estimation module 410, and a buffer time estimation module 412. The preparation time estimation module 408 may receive from the fulfillment facility selection module 402 the order data and the concession data associated with the fulfillment facility 108 identified as being able to fulfill the patron's order. The preparation time estimation module 408 may then estimate from the received data the amount of time the fulfillment facility 108 is expected to take to prepare the order, e.g. cook the corresponding food item, according to the received order data. The preparation time estimation module 408 may then send the order data, the concession data, and the preparation time estimate to the delivery time estimation module 410.

The delivery time estimation module 410 may retrieve from the memory 116 and/or databases 120 venue data indicative of a physical layout or configuration of the venue. For example, the venue data may comprise a location of the seats and fulfillment facilities 108 when more than one fulfillment facility 108 is provided at the venue. Other data relevant to the venue layout may also apply. The delivery time estimation module 410 may then determine from the order data, the concession data, the preparation time estimate, and the retrieved venue data the amount of time a staff member associated with the fulfillment facility 108 and/or venue is expected to take to deliver the prepared order. The delivery time estimation module 410 may then add this estimate of the delivery time to the preparation time estimate computed by the preparation time estimation module 408. The resulting estimate may then be indicative of the overall order fulfillment time and indicate when the patron's order may be delivered. For example, the estimate received from the preparation time estimation module 408 may indicate that the chosen fulfillment facility 108 is expected to take five (5) minutes to prepare the order. The delivery time estimation module 410 may further determine that, given the availability of the staff member and the configuration of the venue, staff member may take two (2) minutes to deliver the prepared order. The delivery time estimation module 410 may then estimate that the order may in fact be delivered to the patron within seven (7) minutes.

The delivery time estimate, order data, and concession data may then be sent to the buffer time estimation module 412, which may compute therefrom an estimate of the buffer time. For this purpose, the buffer time estimation module 412 may retrieve the content data, e.g. live content data, from the memory 116 and/or databases 120. The buffer time estimation module 412 may then estimate from the received and retrieved data a buffer time amount that may be suitable to take into account any unexpected event that may impact the order's delivery time. Such unexpected events may include, but are not limited to, new orders, errors in orders, modified orders, patrons having left their seat at the time of delivery, staff members dropping the prepared order, staff member injuries, etc. An unexpected event may also comprise the process of authenticating the identity (e.g. requesting an identification card indicative of age) of a patron when a staff member is making a delivery for alcoholic beverages. Thus, information stemming from the patron's profile (e.g. requirement to verify patron's age) may lead to unexpected events and therefore have an impact on computation of buffer time.

The buffer time estimation module 412 may therefore identify such unexpected events from the concession data and/or the content data. The buffer time may then be estimated based on the estimated duration of order preparation and delivery by the fulfillment facility 108. The buffer time estimation module 412 may add the computed buffer time estimate to the delivery time estimate received from the delivery time estimation module 410. For example, although the delivery time estimation module 410 may have estimated that the order may be delivered to the patron within seven (7) minutes, the buffer time estimation module 412 may add five (5) minutes to this delivery time estimate. As a result, the buffer time estimation module 412 may then estimate the expected delivery time to be equal to a total of twelve (12) minutes. The result, which illustratively indicates the expected delivery time for the patron's order, may be transmitted to the delivery synchronization module 404. As discussed above, the latter may then be able to estimate a desired delivery time in accordance with the timing of the content presented at the venue and/or on the patron's device 104_{P}.

Referring now to FIG. 2e, the delivery time estimation module 410 illustratively comprises a route optimization module 414, an order batching module 415, and a delivery time computation module 416. The route optimization module 414 may estimate an optimal route to be taken by the staff member(s) associated with the fulfillment facility 108 and/or the venue to deliver the order. The estimation may be obtained from the order data, e.g. order details and patron's location at the venue, the venue data, e.g. physical layout of the venue, retrieved from the memory 116 and/or databases 120, and the preparation time estimate received from the preparation time estimation module 408. The optimal route may also be estimated from the concession data, e.g. the facility's capacity and pending orders. In particular, in addition to depending on the fulfillment facility's capacity, e.g. the number and availability of staff members, the optimal route may vary depending on whether other orders are pending at the fulfillment facility 108 identified by the fulfillment facility selection module 402. Indeed, if orders are pending at the fulfillment facility 108, it may be more efficient for staff members to deliver all orders back-to-back rather than returning to the fulfillment facility 108 after delivering each order. Information about such pending orders may be found in the concession data received from the fulfillment facility selection module 402. Using the received/retrieved data, the route optimization module 414 may thus identify the fastest and most efficient delivery route for staff member to deliver the patron's current order, taking into account pending orders, if any.

For example, the venue data may indicate the venue layout or seating chart 418 illustrated in FIG. 2f. The order data may indicate that, in addition to the present order 420₁, two (2) other orders 420₂ and 420₃ have been received at the system 102. The concession data may indicate that two (2) fulfillment facilities 108₁ and 108₂ are in proximity of the location of the patrons having placed the orders 420₁, 420₂, and 420₃. The preparation time estimates received from the preparation time estimation module 408 may further indicate that each one of the orders 420₁, 420₂, and 420₃ will take one (1) minute to prepare at either fulfillment facility 108₁ or 108₂ for a total preparation time of three (3) minutes for all three orders 420₁, 420₂, and 420₃. It should be understood that, when orders are pending at a given fulfillment facility 108₁ or 108₂, the preparation time estimates may also indicate delays, if any, incurred in-between successive orders.

The concession data may further indicate that each fulfillment facility 108₁ and 108₂ comprises four staff members as in 422₁, 422₂, 422₃ and 422₄ and that only staff member 422₁ of fulfillment facility 108₁ is available to deliver orders. The route optimization module 414 may then determine from the order data the destinations 424₁, 424₂, and 424₃ of the respective orders 420₁, 420₂, and 420₃, i.e. the location of the patrons. According to the delivery destinations, the route optimization module 414 may then identify all possible delivery routes for the orders. In the illustrated case, the possible delivery routes may be route 424₁-424₂-424₃, route 424₁-424₃-424₂, route 424₂-424₁-424₃, route 424₂-424₃-424₁, route 424₃-424₁-424₂, and route 424₃-424₂-424₁. Because location 424₃ is illustratively closer to the facility 108₁ than location 424₂, the route optimization module 414 may then identify route 424₁-424₃-424₂ as being the optimal delivery route in terms of minimizing the distance traveled by staff members and reducing delivery time for each order 420₁, 420₂, and 420₃.

Still referring to FIG. 2e, the route optimization module 414 may communicate with the order batching module 415, which may be used for grouping received orders into subsets or batches to increase the delivery efficiency (e.g. minimize the delivery time for each order). For this purpose, the order batching module 415 may group orders in accordance with the concession data, e.g. the number of staff members available at the fulfillment facility or the physical limit of delivery personnel, i.e. the maximum number of orders each delivery personnel may carry during a given run. The order batching module 415 may further group orders in accordance with the size of the orders to be delivered, the delivery time, or the location(s) to which the orders are to be delivered. It should be understood that other parameters may be taken into account when grouping orders. With knowledge of the above-mentioned parameters, the order batching module 415 may then determine a subset of the received orders that is suitable for being delivered in a same run.

For instance, fifteen (15) orders may be received. If the physical limit of each delivery personnel is five (5) orders, the order batching module 415 may split the orders into three (3) subsets of five (5) small orders each. The patrons having placed the five (5) orders in each subset may further all be located in close proximity to one another so as to reduce the delivery time. If the physical limit of the delivery personnel is greater than five (5) orders, e.g. eight (8) orders, the order batching module 415 may split the orders into two (2) large subsets, namely a first subset of eight (8) orders and a second subset of seven (7) orders. The patrons having placed the orders in each subset may further be located at a greater distance from one another than was the case for the first batching of three subsets. In order embodiments, the order batching module 415 may use the venue layout (as obtained from the venue data received at the route optimization module 414) to group orders according to sections of the venue they are to be delivered to. It should be understood that other grouping may apply and that the manner in which to group orders is illustratively selected so as to achieve a fast and efficient delivery. Once the order batching module 415 has grouped orders into subsets, the corresponding batching information may be sent to the route optimization module 414, which may determine therefrom the route(s) to be followed.

FIG. 2g illustrates an example where route optimization module 414 and the order batching module 415 may be used to determine a suitable grouping of orders, and accordingly an optimal route, in accordance with the order data, the venue data, and the concession data. In the illustrated example, the venue data and the order data may indicate that four (4) consecutive orders 420′₁, 420′₂, 420′₃, and 420′₄ have been received at the system 102. The concession data may indicate that a single fulfillment facility, namely facility 108₁, is in proximity of the locations 424′₁, 424′₂, 424′₃, and 424′₄ of the patrons having placed the orders 420′₁, 420′₂, 420′₃, and 420′₄. The concession data may also indicate that only staff members 422₁ and 422₄ of fulfillment facility 108₁ are available to deliver orders at the present time. In addition, the concession data may indicate that staff member 422₁ will require two (2) minutes to reach either location 424′₁, 424′₂, 424′₄ from the fulfillment facility 108₁ and that the staff member 422₁ will take one (1) minute between locations 424′₁ and 424′₂ and between locations 424′₂ and 424′₃ and four (4) minutes between locations 424′₃ and 424′₄. Thus, if staff member 422₁ alone was to make the delivery of all four orders 420′₁, 420′₂, 420′₃, and 420′₄ in sequence, a total of 2+1+1+4=8 minutes may be required along the route 424′₁-424′₂-424′₃-424′₄. In this scenario, the first order 420′₁ may be received after two (2) minutes, the second order 420′₂ after three (3) minutes, the third order 420′₃ after four (4) minutes, and the fourth order 420′₄ after eight (8) minutes.

The concession data may further indicate that staff member 422₂ will require two (2) minutes to reach either location 424′₁ and 424′₄ from the fulfillment facility 108₁ and that the staff member 422₂ will take two (2) minutes between locations 424′₁ and 424′₄. The route optimization module 414 may then communicate with the order batching module 415 to compute delivery times along various routes for various order groupings and determine the delivery route(s) that allow to minimize the time taken to deliver the order(s) received at a given time. For instance, the route optimization module 414 may then communicate with the order batching module 415 to identify that it may be more efficient to group the orders in a first subset comprising orders 420′₂ and 420′₃ for delivery by staff member 422₁ and a second subset comprising orders 420′₁ and 420′₄ for delivery by staff member 422₂ (as illustrated by the arrows shown in FIG. 2g). In this manner, the first order 420′₁ may be received after two (2) minutes, the second order 420′₂ after two (2) minutes, the third order 420′₃ after three (3) minutes (instead of four (4) minutes if no batching of orders is used), and the fourth order 420′₄ after four (4) minutes (instead of eight (8) minutes if no batching of orders is used).

As discussed above, the grouping of orders and determining of the optimal route may be based on any information from the order data, the venue data, and/or concession data. For instance, the time required by the fulfillment facilities 108 to prepare the order may also be taken into account to determine a route and/or batching of orders that minimizes the time taken to deliver orders. Indeed, taking into account the preparation time, the route optimization module 414 and the order batching module 415 may determine that it would be more efficient to split order preparation and delivery among a plurality of fulfillment facilities 108.

The route optimization module 414 may then output optimal route data indicative of the identified optimal route (e.g. route 424₁-424₃-424₂ in the example discussed above with reference to FIG. 2f or routes 424′₁-424′₄ and 424′₂-424′₃ in the example discussed above with reference to FIG. 2g) and send this optimal route data to the delivery time computation module 416. The route optimization module 414 may also send to the delivery time computation module 416 the concession data indicating the amount of time the staff member is expected to take on each portion of the optimal route. The delivery time computation module 416 may then compute the amount of time it would take staff member to deliver the current order as well as any other pending orders, if any, when traveling on the optimal delivery route. As shown in FIG. 2f, the delivery time computation module 416 may for instance determine that, taking the route 420₁-420₃-420₂, order 420₁ may be delivered at location 424₁ in five (5) minutes, order 420₂ may be delivered at location 424₂ in nine (9) minutes, and order 420₃ may be delivered at location 424₃ in seven (7) minutes.

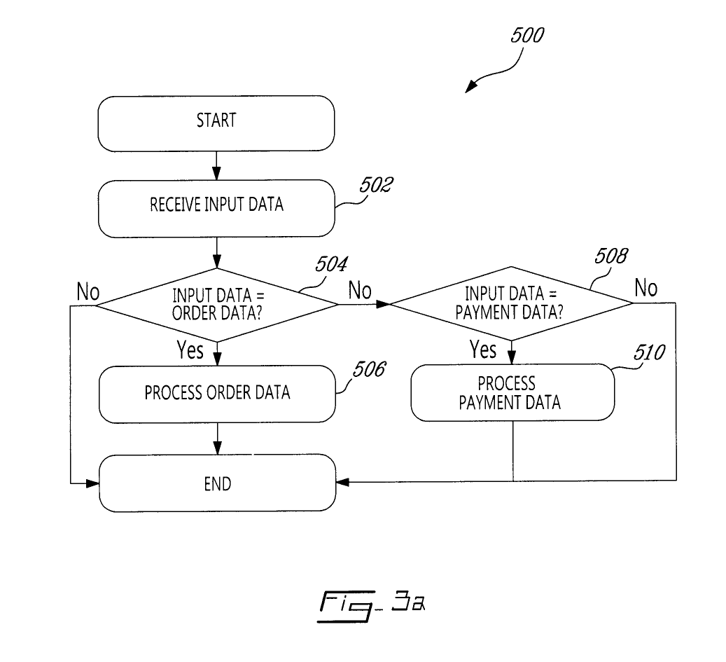

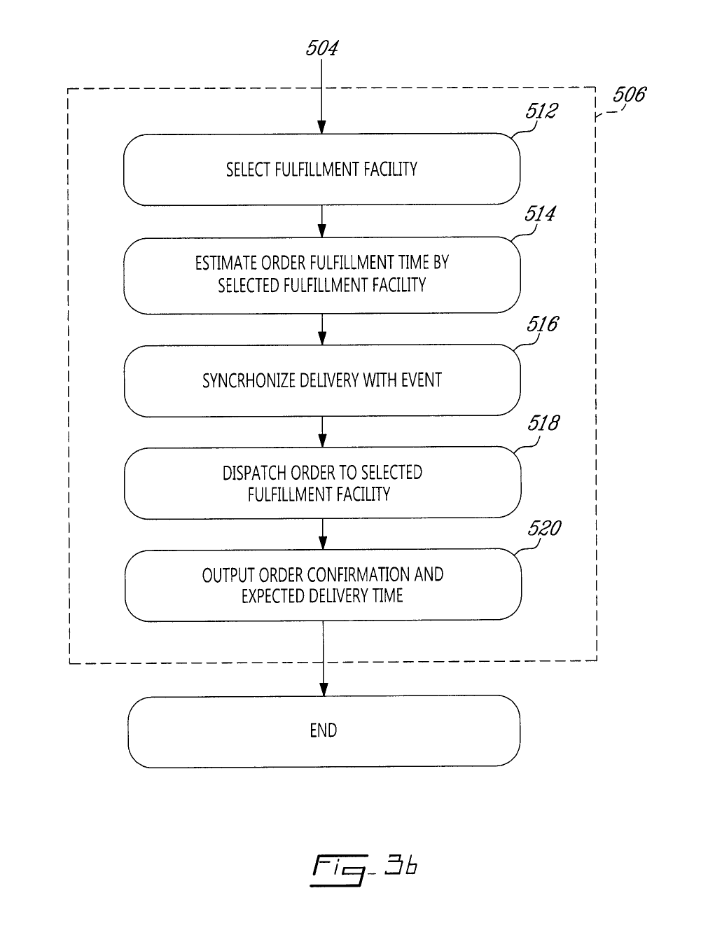

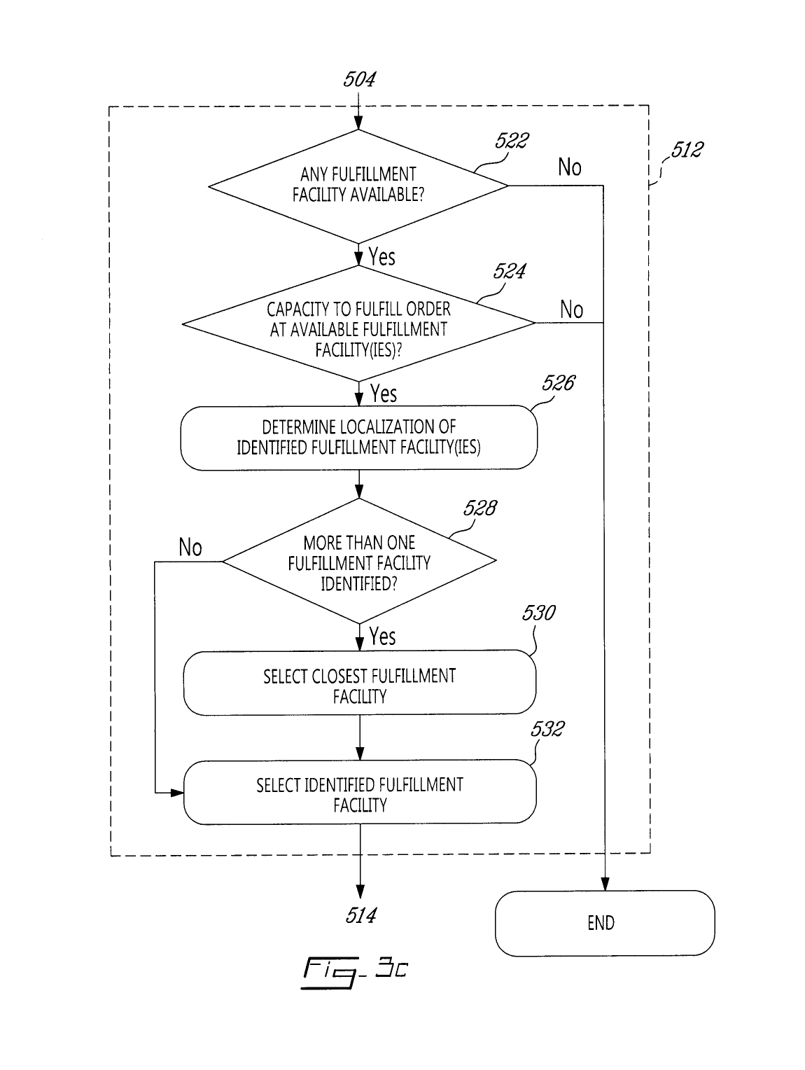

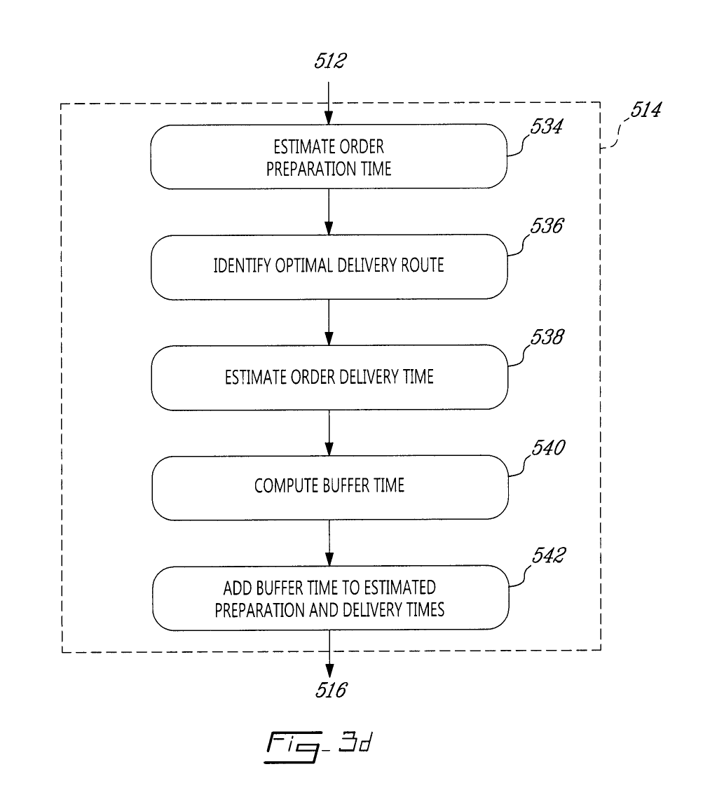

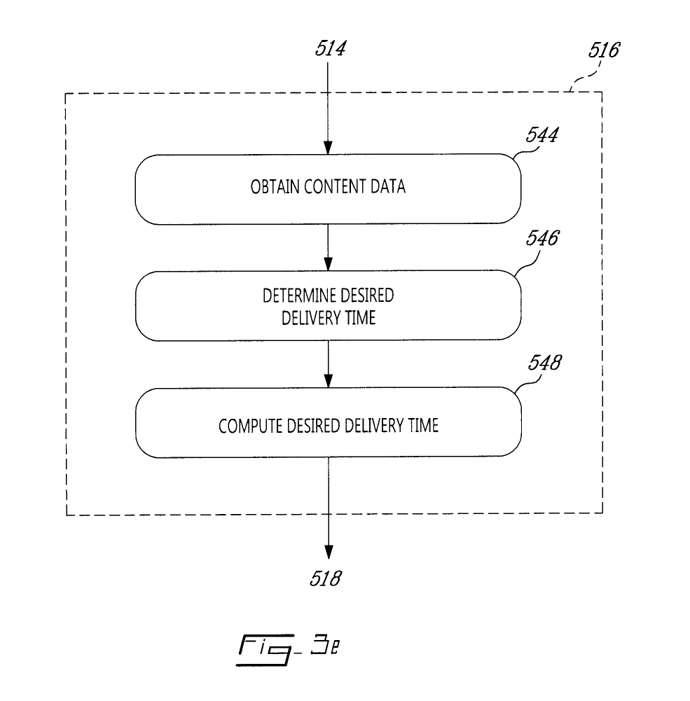

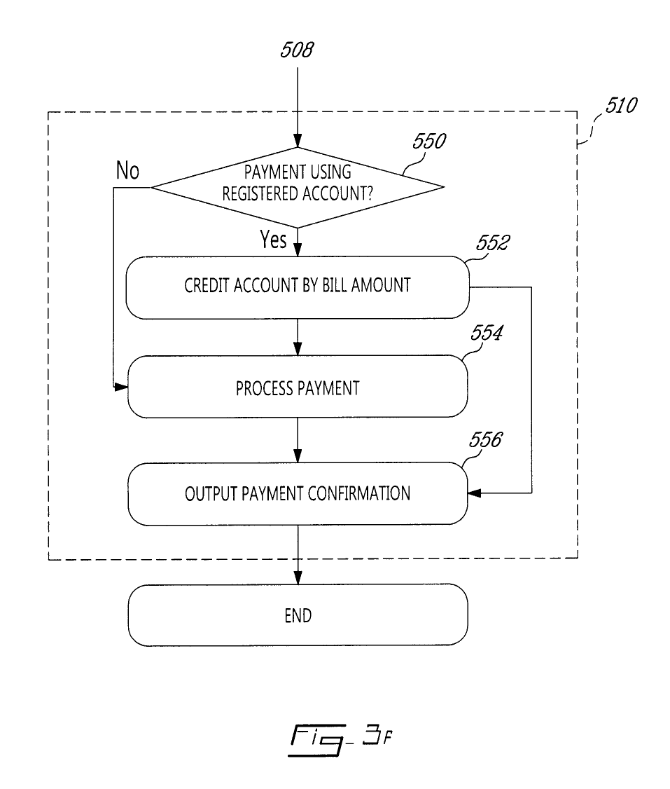

Referring to FIG. 3a, a method 500 for managing venue concessions will now be described. The method 500 comprises receiving input data at step 502 and determining at step 504 whether the input data is order data. If this is the case, the order data is processed at step 506. Otherwise, the method 500 may end or optionally assess at step 508 whether the input data is payment data. If the input data is payment data, the latter may be processed at step 510. If the input data is not payment data, the method 500 illustratively ends.

Referring to FIG. 3b, the step 506 of processing the order data illustratively comprises selecting one (or more if orders may be split, as discussed above) fulfillment facility at step 512, estimating the order fulfillment time by the selected fulfillment facility at step 514, synchronizing at step 516 the delivery of the order with the event at the venue, dispatching the order to the selected fulfillment facility at step 518, and outputting an order confirmation as well as an expected delivery time at step 520. As discussed above, the step 506 may comprise a step (not shown) of outputting an order confirmation request message for requesting confirmation of the order by the patron. This step may be performed prior to step 518 such that the order is only upon receipt of the patron's confirmation of the order.

Referring to FIG. 3c, the step 512 of selecting a fulfillment facility comprises determining at step 522 whether any fulfillment facility 108 is available. If no fulfillment facility 108 is available, the method 500 may end. Otherwise, the next step 524 may be to determine whether the available fulfillment facility (or facilities) 108 has the capacity to fulfill the order. If none of the available fulfillment facilities 108 have the capacity to fulfill the order, the method 500 may end. Otherwise, the localization of the identified fulfillment facility(ies) 108 may be determined at step 526. This may be obtained from the concession data stored in the memory 116 and/or databases 120. The next step 528 may then be to determine whether more than one fulfillment facility 108 has been identified. If this is the case, the closest fulfillment facility 108 among the identified fulfillment facilities 108 may be selected at step 530. Otherwise, if only one fulfillment facility 108 has been identified, the identified fulfillment facility 108 may be selected at step 532. The preparation and delivery times at the selected facility may then be estimated at step 514.

Referring to FIG. 3d, the step 514 of estimating the order fulfillment time by the selected fulfillment facility illustratively comprises estimating the order preparation time at step 534. The next step 536 may be to identify an optimal delivery route taking into account the order data, the preparation time estimate, the concession data, and the venue data, as discussed above with reference to FIG. 2e. The step 536 may further comprise grouping orders to optimize delivery thereof in the manner discussed above when describing acts performed by the order batching module (reference 415 in FIG. 2e). The order delivery time may then be estimated at step 538 supposing the staff member delivers the patron's order along the optimal delivery route identified at step 536. The buffer time used to take into account any unexpected event may then be computed at step 540 and added at step 542 to the preparation and delivery times estimated at steps 534 and 538.

Referring to FIG. 3e, the step 516 of synchronizing the delivery with the event illustratively comprises obtaining at step 544 content data, such as live content data, replay content data, commercials content data, and interactive content data, from the content provider 110 and/or the memory 116 and databases 120. As discussed above, such content data may comprise information about the timing of the content to be delivered to the patrons' devices 104_{P} and/or presented at the venue. The next step 546 may then be to correlate the fulfillment time estimate obtained at step 514 with the timing of the content data. As discussed above with reference to FIG. 2b, such a correlation enables to compute at step 548 a desired delivery time. For example, the delivery of the order may be synchronized with the timing of breaks in the live event occurring at the venue and the desired delivery time may be set accordingly. The step 548 may be performed in the manner discussed above when describing the delivery synchronization module (reference 404 in FIG. 2b and FIG. 2c). Also, the step 516 may further comprise correlating the standard time with the event time to estimate the desired delivery time at step 546.

Referring to FIG. 3f, the step 510 of processing the payment data illustratively comprises assessing at step 550 whether the payment is to be made using the user's registered account. If this is the case, the user's account may be credited by the bill amount at step 552. Otherwise, the payment may then be processed at step 554 using standard credit card payment methods or others known to those skilled in the art. A payment confirmation may then be output at step 556. Although not illustrated, it should be understood that prior to performing step 550, a request may be generated and output to request the patron to confirm he/she authorizes payment for the order. Once payment authorization has been received, the method may proceed with step 550.

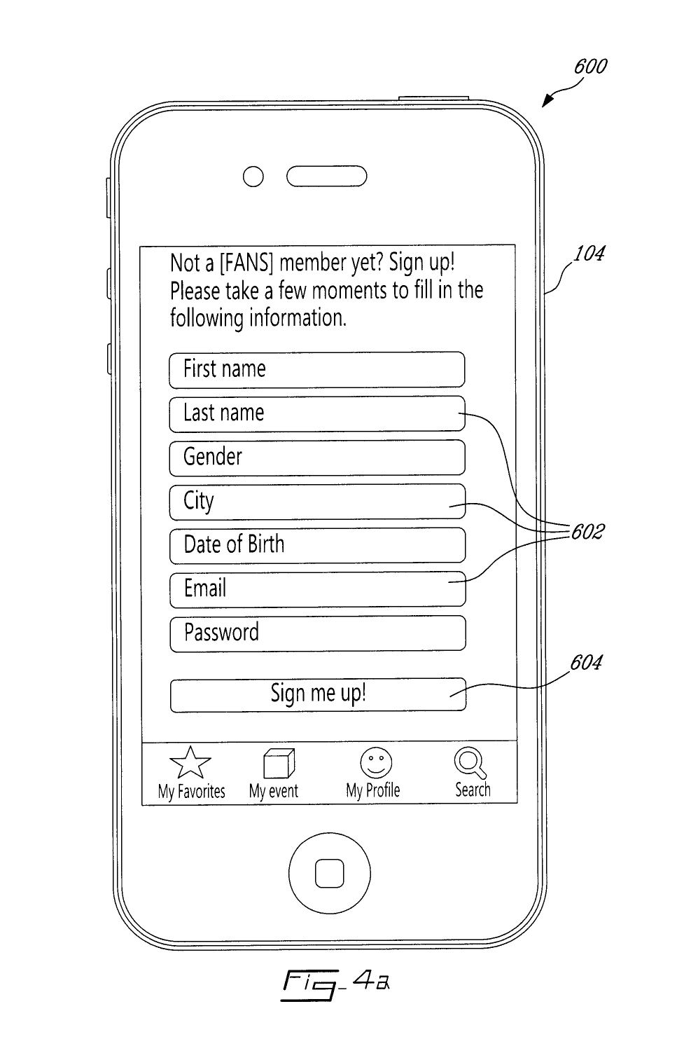

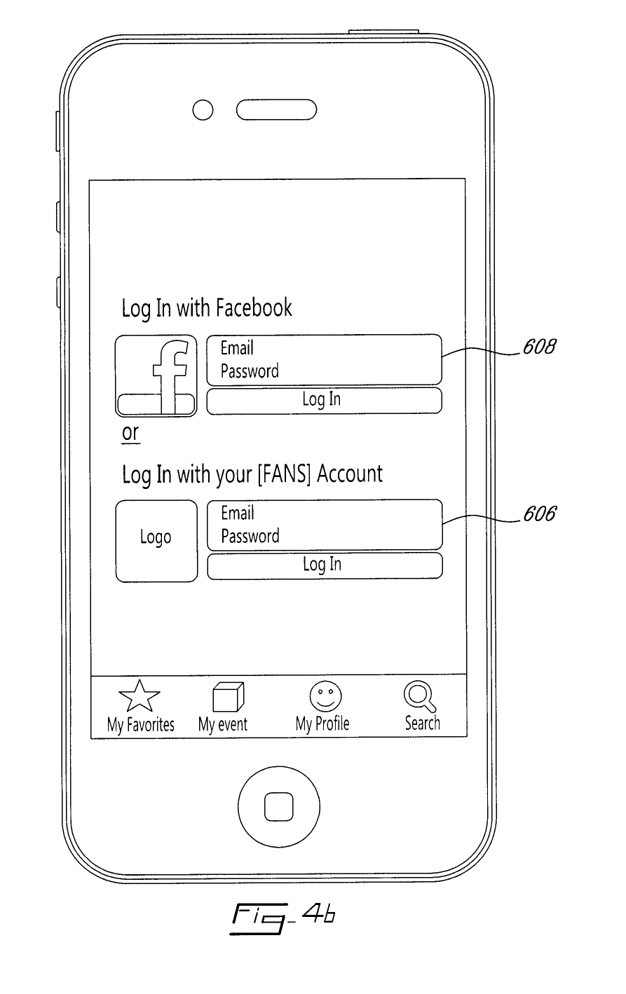

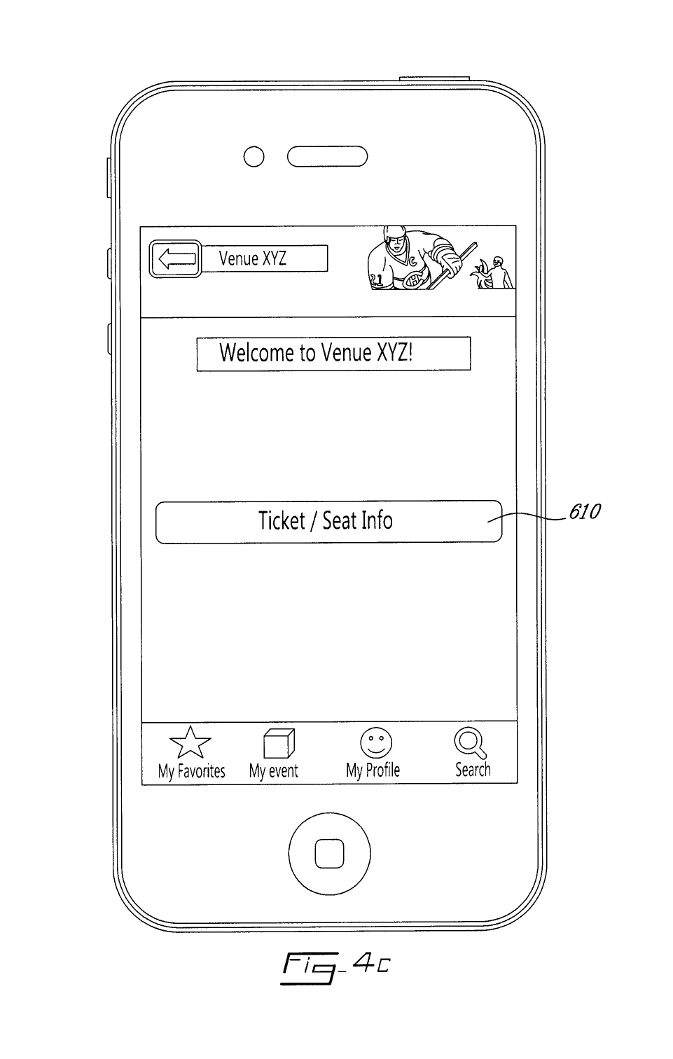

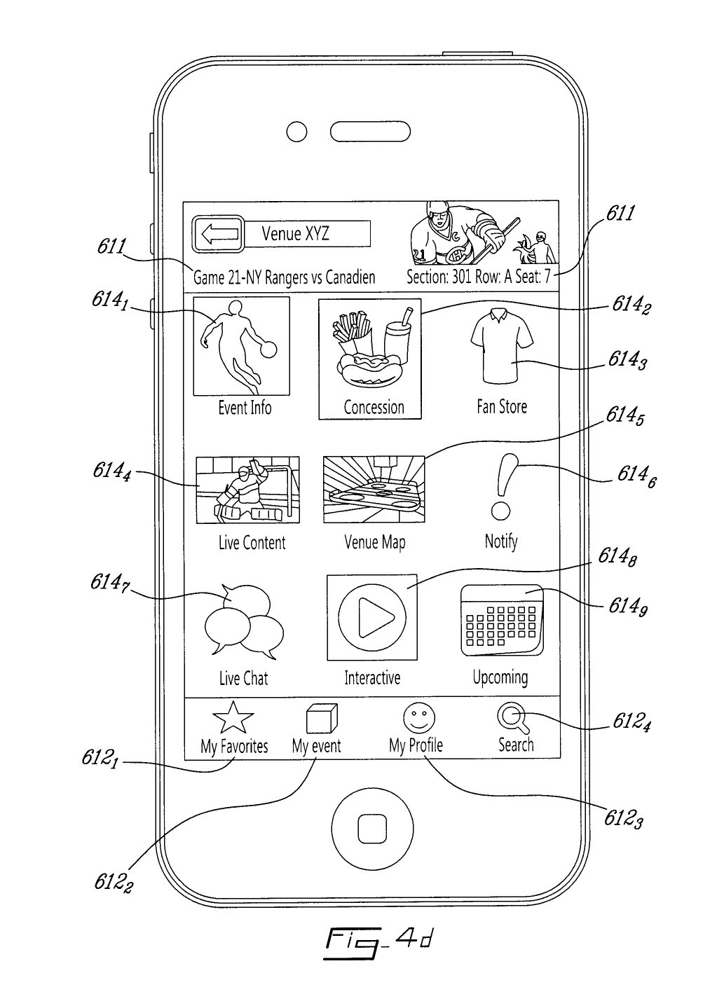

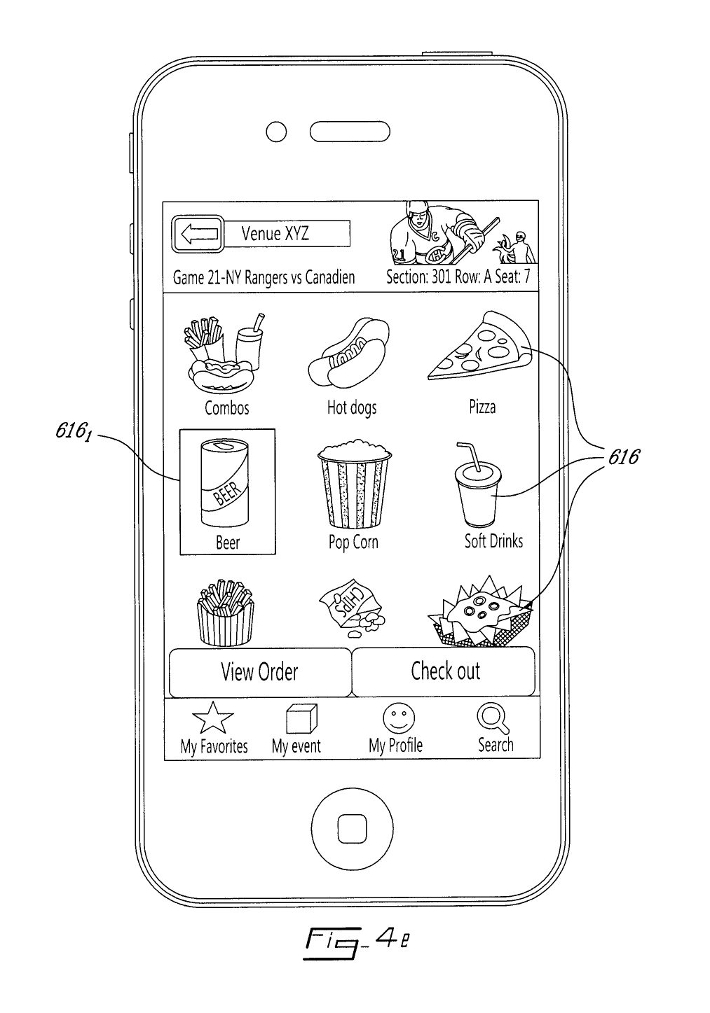

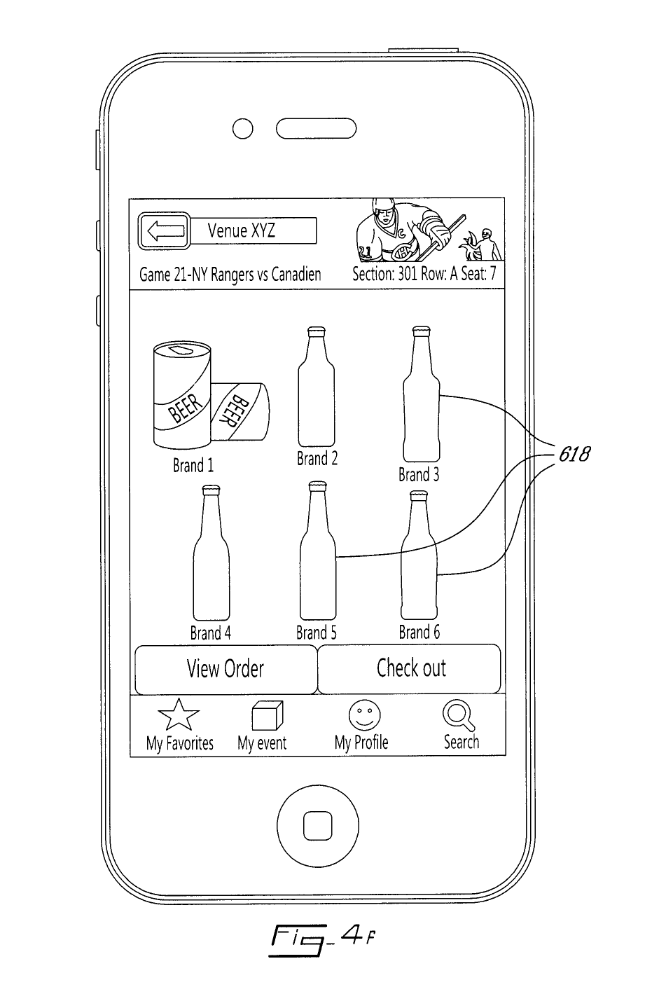

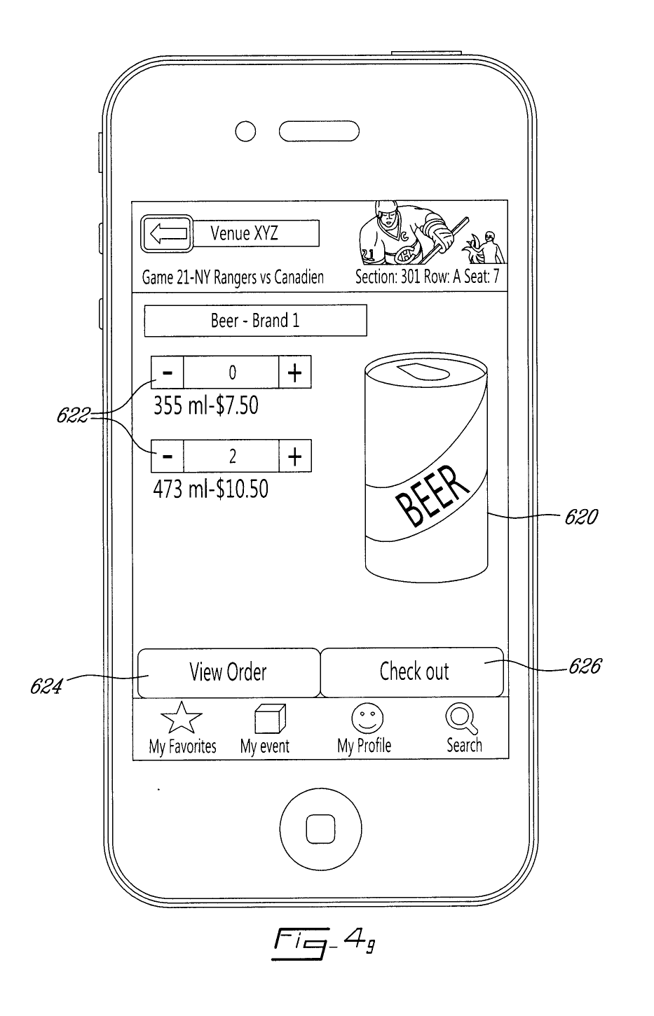

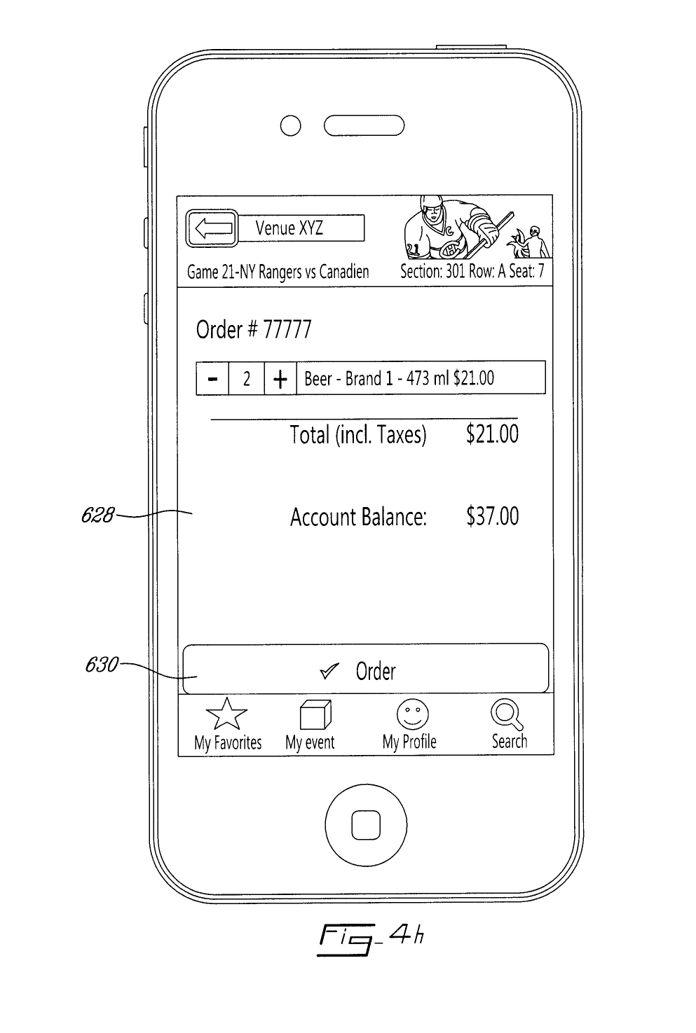

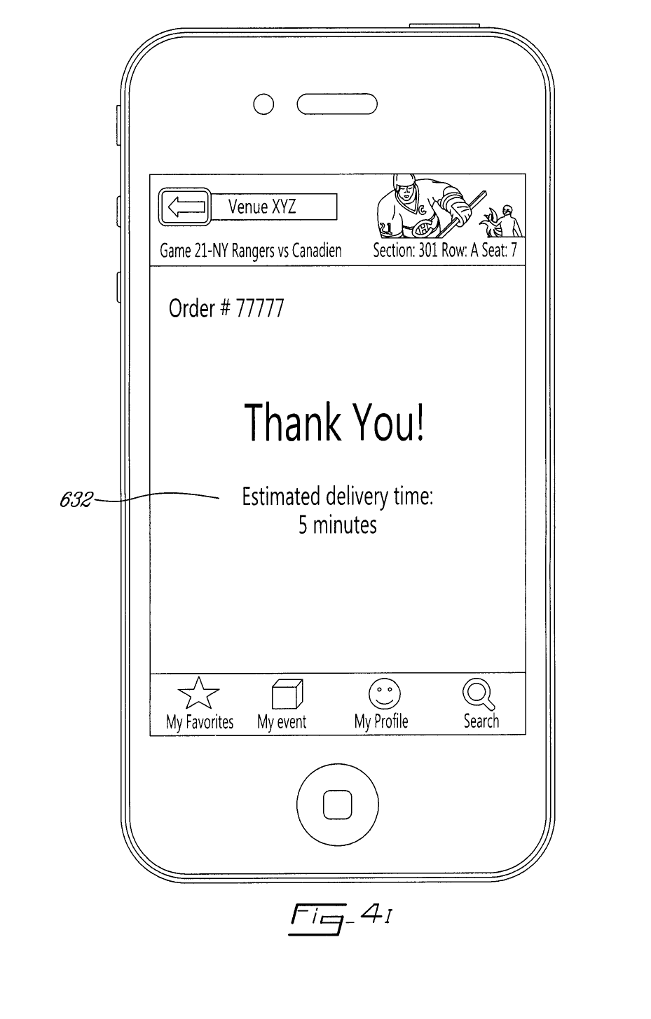

FIG. 4a illustrates a screen capture of a user interface 600 presented on the screen of a patron device 104_{P}. The user interface 600 illustratively comprises a user selected menu presented to the patron to enable the latter to browse information, order products, and other functionalities. As discussed above, the patrons illustratively register with the system 102 in order to access services provided at the venue. For this purpose, the user interface 600 illustratively comprises a plurality of user interface elements 602, such as text boxes allowing for lines of free text to be entered. In this manner, the patron may provide the information required for completing their application, thereby creating their unique profile. For example, the patron may enter information included, but not limited to, their name, gender, home address, email address, which may be used as the patron's username for logging into the system 102, and a password that will be associated with the patron's account in the system 102. Other information or attributes, such as an age of the patron or their interests (as described above), may also be provided to complete the patron's profile. Once the information has been properly entered, a “Sign me up!” option 604 may be selected on the user interface 600 to submit the information.

Referring to FIG. 4b, once registration is complete and the patron's profile has been created, the patron may be prompted to log into the system 102 by the user interface 600 presenting a login interface element 606. Using such an interface element 606, the patron may enter the unique identifier, i.e. username and password, associated with their profile. As discussed above, it should be understood that patrons may log into the system 102 using an identifier associated with an online social network or social networking application (e.g. Facebook™, Google+™, Twitter™ or the like) to which the patron has subscribed. For this purpose, a corresponding user interface element 608 may be presented to the patron.

Referring to FIG. 4c, once the patron has logged into the system 102 using their identifier and selected the venue, e.g. venue XYZ, they wish to obtain services from, the patron may further be presented with an interface element 610 for providing ticket/seat information. In particular, upon selection of the interface element 610, the patron may load into the system 102 information about their ticket and/or seat number at the chosen venue. The information may be loaded by the patron scanning a portion, e.g. a barcode (one dimensional or two dimensional, i.e. a matrix barcode), or the entirety of their ticket using a suitable scanning device, e.g. a camera, coupled to their device 104_{P}. Information associated with the ticket, e.g. ticket/seat number, may then be obtained from a ticket issuer and loaded into the system 102 and/or the databases 120 further to the scanning process. The information may also be manually entered by the patron using suitable interface elements (not shown) presented on the device 104_{P}. The patron may also select an electronic ticket issued by the venue. Authentication of the patron may then be performed using the provided ticket information. In addition, the system 102 may determine from the received scanning data the patron's localization (e.g. seat, row, and/or section number) within the venue. This may be useful for optimizing the delivery of patron orders, as discussed above.

Referring to FIG. 4d in addition to FIG. 4c, once the patron has been authenticated, the ticket/seat information may be presented in fields 611 of the interface 600 along with relevant account and/or event/venue information. Indeed, the user interface 600 may present the patron with a plurality of functionalities each associated with a service offered by the system 102 and/or the content provider 110. For example, a “My Favorites” functionality 612₁, a “My Event” functionality 612₂, a “My Profile” functionality 612₃, and a “Search” functionality 612₄ may be presented as selectable icons. A patron may select one of the functionalities 612₁, 612₂, 612₃, and 612₄ using one of a variety of selection means. For example, if the screen of the device 104_{P} is a touchscreen, selection may be effected by touching on the screen an icon corresponding to a given functionality. Other selection means, such as a mouse, a keyboard, a pointing device, and the like (not shown), coupled to the device 104_{P} may also be used by the patron to select any desired icon presented on the user interface 600. Also, a variety of screen selection/manipulation means other than icons, e.g. tabs, buttons, and the like, may apply.

The “My Favorites” functionality 612₁ may, upon being selected, provide the patron with information about their favorite artists, entertainers, teams, and the like, as indicated in the patron's profile. The “My Event” functionality 612₂ may, upon being selected, provide the patron with information about the list of venues the patron may log into using the system 102, as indicated in the patron's profile. It should be understood that the list of venues may be acquired on the basis of the patron's localization obtained using a positioning system, e.g. Global Positioning System (GPS) system, or other localization techniques known to those skilled in the art. The list of venues may, for example, comprise all venues within proximity of the patron's home address. The “My Profile” functionality 612₃ may, upon being selected, provide the patron with information about their profile. Using the functionality 612₃, the patron may for instance view their account balance and load money into their account using electronic payment solutions and/or redeemable vouchers. The “Search” functionality 612₄ may, upon being selected, enable the patron to search the memory 116 and/or databases 120 for information about artists, entertainers, teams, venues, services provided by the system 102, and the like. The search results may then be added to the patron's favorites using the “My Favorites” functionality 612₁ or the “My Event” functionality 612₂.

Information pertaining to the various services available in relation with the venue and/or the event may further be presented on the interface 600. For example, a main menu may display a plurality of icons each associated with the available services, such as an “Event Info” icon 614₁, a “Concession” icon 614₂, a “Fan Store” icon 614₃, a “Live Content” icon 614₄, a “Venue Map” icon 614₅, a “Notify” icon 614₆, a “Live Chat” icon 614₇, an “Interactive” icon 614₈, and an “Upcoming” icon 614₉. Upon selection of one of the icons 614₁, 614₂, 614₃, and 614₄, the patron may then be presented with sub-menus detailing the corresponding service.

The “Event Info” icon 614₁ may be used to obtain information, e.g. tour information, biography of artists, song lyrics, sports teams and player information, statistics, rankings, etc., about the event occurring at the venue. The “Concession” icon 614₂ may be used for patrons to order and pay for food and beverages using the device 104_{P}. Patrons may then pick up their order or have it delivered to their location, e.g. to their seat, as discussed above. The “Fan Store” icon 614₃ may be used to access a catalogue of merchandise, e.g. sports apparel, jerseys, and other fan gear, related to the venue or the event. The patron may then order, pay, and pick-up the merchandise at a main store or have it delivered to their location. The “Live Content” icon 614₄ may be used to receive live content, e.g. news feeds, highlights, replays, and exclusive content, about the event in real time. The “Venue Map” icon 614₅ may be used to view an interactive map of the venue and thereby locate seats, concessions, merchandising stands, nearest exits, restrooms, special zones, and the like. The “Venue Map” icon 614₅ may also be used by the patron to localize his/her social network friends present at the venue. The “Notify” icon 614₆ may provide text entry space to enable patrons to report incidents, request assistance in case of an emergency or other event, ask questions, and the like. The “Live Chat” icon 614₇ may be used to enable patrons to communicate with moderators or venue organizers in a simulated discussion. In this manner, patrons may be provided with information about the venue and/or event at any point during the event, such as during intermissions. The “Interactive” icon 614₈ may be used to view interactive content, such as games, contests, quizzes, live surveys, and the like, provided by the content provider 110. The “Upcoming” icon 614₉ may be used to obtain information about upcoming events at the venue. The “Upcoming” icon 614₉ may also be used to purchase tickets for these upcoming events through a ticketing platform associated with the venue or the event.

It should be understood that the label, number, placement, order, and format of at least the icons 612₁, 612₂, 612₃, 612₄, 614₁, 614₂, 614₃, 614₄, 614₅, 614₆, 614₇, 614₈, and 614₉ may vary depending on the content, products, and services offered at the venue. Also, the main menu may be tailored to the preferences of the patron, as indicated in their profile. Examples of venue services comprise, but are not limited to, concession services, fan store or fan club services, season ticket holder services, event information, live content, venue map, interactive content, live chat, upcoming events, notification services, social media integration, localization of social network friends present at the venue, parking management, suite management, fan cam, fundraising, charity lottery, silent auctions, loyalty programs, badges or ticket history, fine dining reservation services, gaming marking, and statistics. Using their devices 104_{P} and through their online social network or social networking application, patrons may recommend and/or share with other users any content, product, or service associated with the icons 614₁, 614₂, 614₃, 614₄, 614₅, 614₆, 614₇, 614₈, and 614₉.

Referring now to FIG. 4e, once the patron has selected the “Concession” icon 614₂, he/she may be presented with a food/beverage sub-menu detailing the food/beverage categories, e.g. hot dogs, pizza, and soft drinks, available at the venue. Each food/beverage category may be represented by a corresponding icon 616. Upon the patron choosing a given food/beverage category by selecting the corresponding icon 616, information detailing the food/beverage items associated with the selected category may be presented on the device 104_{P}. For example, upon the patron selecting the “Beer” icon 616₁, a corresponding “Beer” sub-menu may be presented on the device 104_{P}, as shown in FIG. 4f. In particular, the sub-menu may present the patron with a plurality of icons 618 each representing a particular item, e.g. brand, of the “Beer” category. By selecting the corresponding icon 618 on the screen of the device 104_{P}, the patron may then choose a given item of the selected food/beverage category, e.g. the “Beer” category, to obtain information, such as brand, price, nutritional, and other relevant information, and place an order for the item.

Referring to FIG. 4g, once the patron has selected a food/beverage item via the corresponding icon 618, an ordering menu may then be presented on the device 104_{P}. The ordering menu may allow the patron to select, preview, correct, or change selected food/beverage items before submission of an order. In particular, an image 620 of the selected item may be presented along with information about the item. Also, one or more user interface elements 622 enabling the patron to choose the number of items to be ordered may be provided. For example, using an interface element 622, the patron may add two (2) units of “Brand 1” beer. The patron may then opt to view details, e.g. number of ordered items and cost, of the order by selecting a corresponding “View Order” option 624 presented on the device 104_{P}. By selecting a corresponding “Check Out” option 626, the patron may further be directed to a screen enabling him/her to indicate confirmation of the order. The ordering menu may also enable the patron to cancel the order by selecting a corresponding cancel option (not shown).

As shown in FIG. 4h, upon completing the order and selecting the “Check Out” option 626, the patron may be presented with a payment screen 628. The payment screen 628 may summarize order details, such as the order number, the ordered items, and the cost. If the patron has subscribed for electronic payment through their registered account, the patron's account balance may also be displayed on the payment screen 628. The patron may then select an “Order” option 630 to proceed with placement of the order. As shown in FIG. 4i, the user interface 600 may then present a confirmation screen 632 indicating confirmation of placement of the order. The confirmation screen 632 may further present a delivery time estimate computed by the delivery synchronization module 404 of FIG. 2b. Any update messages may also be presented on the confirmation screen 632. After the patron has placed an order and prior to presentation of the confirmation screen 632, a terms of service screen (not shown) may also be presented to indicate to the user the rules they agree to abide by in order to use the system 102. For example, the patron may be prompted to agree to remain at their seat until the order is delivered.

Upon the patron selecting the order placement option 630, the order is illustratively dispatched by the order processing module 304 of FIG. 2a to the appropriate fulfillment facility 108. Upon receiving the order, the fulfillment facility 108 may then prepare the order according to the received order data and delivery timing data. The prepared order may then be delivered to the patron's location, e.g. seat number, according to the desired delivery time computed by the delivery synchronization module 404. In this manner, the fulfillment facility 108 can ensure that delivery of the patron's order is synchronized with the event, and more particularly with a timing thereof, in the manner discussed above.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system and/or on a computer readable medium. The embodiments of the invention described above are intended to be exemplary only. The scope of the invention is therefore intended to be limited solely by the scope of the appended claims.

1. A system for synchronizing delivery at a venue of at least one product with a live event occurring at the venue, the at least one product offered at the venue by at least one fulfillment facility, the system comprising:
a memory;
a processor; and
at least one application stored in the memory and executable by the processor for
receiving an order signal comprising order data indicative of an order for the delivery of the at least one product to a location of the venue,
receiving an event signal comprising event data indicative of a timing of the live event, determining from the event data a desired delivery time at which to deliver the order to the location such that delivery of the order matches the timing of the live event, and
generating and transmitting a control signal to the at least one fulfillment facility for causing the at least one fulfillment facility to prepare and deliver the order to the location by the desired delivery time.

2. The system of claim 1, wherein the memory has stored therein facility data indicative of an ability of the at least one fulfillment facility to prepare and deliver the order and wherein the at least one application is executable by the processor for retrieving the facility data from the memory, determining from the retrieved facility data and the order data a fulfillment timespan required for the at least one fulfillment facility to prepare and deliver the order, comparing the fulfillment timespan to the desired delivery time, and updating the desired delivery time on the basis of the comparison.

3. The system of claim 2, wherein the memory has stored therein the facility data comprising at least one of a current capacity of the at least one fulfillment facility to prepare the order, a current availability of the at least one fulfillment facility to at least one of prepare and deliver the order, a number of staff at the at least one fulfillment facility, a location of the at least one fulfillment facility, and a location of the staff.

4. The system of claim 2, wherein the at least one application is executable by the processor for updating the desired delivery time comprising determining an alternate desired delivery time if the fulfillment timespan exceeds the desired delivery time, and maintaining the desired delivery time otherwise.

5. The system of claim 1, wherein the memory has stored therein venue data indicative of a physical layout of the venue and wherein the at least one application is executable by the processor for retrieving from the memory the venue data, determining the desired delivery time comprising determining from the retrieved venue data and the order data an optimal route for delivering the order by the desired delivery time, generating the control signal comprising the optimal route, and transmitting the control signal to the at least one fulfillment facility for causing the at least one fulfillment facility to deliver the order according to the optimal route.

6. The system of claim 5, wherein the at least one application is executable by the processor for receiving the order signal comprising the order data indicative of a plurality of orders for the at least one product to be delivered to a plurality of locations of the venue, determining on the basis of at least one of the order data, the facility data, and the venue data one or more subsets of the plurality of orders that minimize a duration taken to deliver each one of the plurality of orders, the optimal route comprising a route for delivering the one or more subsets, generating the control signal indicative of the one or more order subsets, and transmitting the control signal to the at least one fulfillment facility for causing the at least one fulfillment facility to deliver the one or more subsets.

7. The system of claim 1, wherein the at least one application is executable by the processor for receiving the event signal comprising the event data indicative of the timing of at least one activity expected to occur at an activity time during a course of the live event, for determining from the order data an order time at which the order is received, and for determining the desired delivery time comprising determining the activity time chronologically closest to the order time and setting the desired delivery time as the activity time.

8. The system of claim 7, wherein the event data is indicative of the timing of the at least one activity comprising at least one of an interruption, a replay, and an interactive activity.

9. The system of claim 7, wherein the memory has stored therein past event data indicative of occurrence of the expected at least one activity during a course of a past event at the venue, and wherein the at least one application is executable by the processor for retrieving the past event data and applying a probabilistic model to determine from the past event data a probability of occurrence of the expected at least one activity during a course of the live event.

10. The system of claim 2, wherein the at least one application is executable by the processor for determining the fulfillment timespan comprising computing from the facility data a first timespan required for the at least one fulfillment facility to prepare the order and a second timespan required for the at least one fulfillment facility to deliver the order, estimating a third timespan of at least one unexpected event having a potential impact on at least one of preparation and delivery of the order by the at least one fulfillment facility, and computing a sum of the first timespan, the second timespan, and the third timespan to obtain the fulfillment timespan.

11. The system of claim 1, wherein the at least one application is executable by the processor for receiving the order data comprising seat location indicia uniquely identifying a selected one of plurality of physical spaces of the venue, the selected one of plurality of physical spaces uniquely assigned to an attendee having placed the order, and for transmitting the order data and the desired delivery time to the at least one fulfillment facility for causing the at least one fulfillment facility to deliver order to the selected one of plurality of physical spaces.

12. The system of claim 1, wherein the memory has stored therein a plurality of identifiers each uniquely identifying a corresponding one of a plurality of attendees at the venue and having associated therewith at least one attribute for the corresponding one of the plurality of attendees, and wherein the at least one application is executable by the processor for receiving the order data comprising a selected one of the plurality of identifiers, retrieving from the memory the at least one attribute associated with the selected one of the plurality of identifiers, and transmitting the order data and the desired delivery time to the at least one fulfillment facility for causing the at least one fulfillment facility to prepare and deliver order in accordance with the at least one attribute.

13. A computer-implemented method for synchronizing delivery at a venue of at least one product with a live event occurring at the venue, the at least one product offered at the venue by at least one fulfillment facility, the method comprising:
receiving an order signal comprising order data indicative of an order for the delivery of the at least one product to a location of the venue;
receiving an event signal comprising event data indicative of a timing of the live event;
determining from the event data a desired delivery time at which to deliver the order to the location such that delivery of the order matches the timing of the live event; and
generating and transmitting a control signal to the at least one fulfillment facility for causing the at least one fulfillment facility to prepare and deliver the order to the location by the desired delivery time.

14. The method of claim 13, further comprising retrieving from a memory facility data indicative of an ability of the at least one fulfillment facility to prepare and deliver the order, determining from the retrieved facility data and the order data a fulfillment timespan required for the at least one fulfillment facility to prepare and deliver the order, comparing the fulfillment timespan to the desired delivery time, and updating the desired delivery time on the basis of the comparison.

15. The method of claim 14, wherein the facility data stored in the memory comprises at least one of a current capacity of the at least one fulfillment facility to prepare the order, a current availability of the at least one fulfillment facility to at least one of prepare and deliver the order, a number of staff at the at least one fulfillment facility, a location of the at least one fulfillment facility, and a location of the staff.

16. The method of claim 14, further comprising updating the desired delivery time comprising determining an alternate desired delivery time if the fulfillment timespan exceeds the desired delivery time, and maintaining the desired delivery time otherwise.

17. The method of claim 13, further comprising retrieving from the memory venue data indicative of a physical layout of the venue, determining the desired delivery time comprising determining from the retrieved venue data and the order data an optimal route for delivering the order by the desired delivery time, generating the control signal comprising the optimal route, and transmitting the optimal route to the at least one fulfillment facility for causing the at least one fulfillment facility to deliver the order according to the optimal route.

18. The method of claim 17, wherein the received order data is indicative of a plurality of orders for the at least one product to be delivered to a plurality of locations of the venue, the method further comprising determining on the basis of at least one of the order data, the facility data, and the venue data one or more subsets of the plurality of orders that minimize a duration taken to deliver each one of the plurality of orders, the optimal route comprising a route for delivering the one or more subsets, generating the control signal indicative of the one or more order subsets, and transmitting the control signal to the at least one fulfillment facility for causing the at least one fulfillment facility to deliver the one or more subsets.

19. The method of claim 13, wherein the received event signal comprises the event data indicative of the timing of at least one activity expected to occur at an activity time during a course of the live event, the method further comprising determining from the order data an order time at which the order is received, and determining the desired delivery time comprises determining the activity time chronologically closest to the order time and setting the desired delivery time as the activity time.

20. The method of claim 19, wherein the event data is indicative of the timing of the at least one activity comprising at least one of an interruption, a replay, and an interactive activity.

21. The method of claim 19, further comprising applying a probabilistic model to determine from past event data a probability of occurrence of the expected at least one activity during a course of the live event, the past event data retrieved from a memory and indicative of occurrence of the expected at least one activity during a course of a past event at the venue.

22. The method of claim 13, to wherein determining the fulfillment timespan comprises computing from the facility data a first timespan required for the at least one fulfillment facility to prepare the order and a second timespan required for the at least one fulfillment facility to deliver the order, estimating a third timespan of at least one unexpected event having a potential impact on at least one of preparation and delivery of the order by the at least one fulfillment facility, and computing a sum of the first timespan, the second timespan, and the third timespan to obtain the fulfillment timespan.

23. The method of claim 13, wherein the received order data comprises a selected one of a plurality of identifiers retrieved from a memory, each one of the plurality of identifiers uniquely identifying a corresponding one of a plurality of attendees at the venue and having associated therewith at least one attribute for the corresponding one of the plurality of attendees, the method further comprising retrieving from the memory the at least one attribute associated with the selected one of the plurality of identifiers, and transmitting the order data and the desired delivery time to the at least one fulfillment facility for causing the at least one fulfillment facility to prepare and deliver order in accordance with the at least one attribute.

24. A computer readable medium having stored thereon program code executable by a processor for synchronizing delivery at a venue of at least one product with a live event occurring at the venue, the at least one product offered at the venue by at least one fulfillment facility, the program code executable for:
receiving an order signal comprising order data indicative of the order for the delivery of the at least one product to a location of the venue,
receiving an event signal comprising event data indicative of a timing of the live event,
determining from the event data a desired delivery time at which to deliver the order to the location such that delivery of the order matches the timing of the live event, and
generating and transmitting a control signal to the at least one fulfillment facility for causing the at least one fulfillment facility to prepare and deliver the order to the location by the desired delivery time.
